(19) United States
(12) Patent Application Publication
(10) Pub. No.: US 2017/0013309 A1
(43) Pub. Date: Jan. 12, 2017

(54) SYSTEM AND METHOD FOR PRODUCT PLACEMENT

(71) Applicant: Bobbli, Inc., Tunis (TN)

(72) Inventor: Zied JALLOULI, Tunis (TN)

(21) Appl. No.: 15/211,676

(22) Filed: Jul. 15, 2016

Related U.S. Application Data
(63) Continuation of application No. PCT/IB15/00359, filed on Jan. 15, 2015.
(60) Provisional application No. 61/927,966, filed on Jan. 15, 2014.

(51) Int. Cl. H04N 21/442; H04N 21/234; H04N 21/43; H04N 21/4147; H04N 21/81; H04N 21/41

(52) U.S. Cl. CPC H04N 21/44218; H04N 21/812; H04N 21/4126; H04N 21/4302; H04N 21/4147; H04N 21/23424

(57) ABSTRACT

A system and method for product placement are disclosed in which the system has a consumer application that provides synchronized tagged frames to the user generated by the system. The consumer application may be displayed on a computing device separate from the display on which the content is being viewed. When the user selects a tag in a frame, information about the item or person is displayed. The application may allow a gesture to be used to capture a moment of interest in the content. The tagging of the system may utilize various source of information (including for example, scripts and subtitles) to generate the tag for the frames of the piece of content.

### PRIORITY CLAIMS/RELATED APPLICATIONS

This application claims priority from and is a continuation of PCT International Patent Application PCT/IB15/00359 filed Jan. 15, 2015 and titled “System and Method for Product Placement”, which claims the benefit under 35 USC 119(e) to U.S. Provisional Patent Application Ser. No. 61/927,966, filed on Jan. 15, 2014 and titled “Method and System for Merging Product Placement With E-Commerce and Discovery”, the entirety of which is incorporated herein by reference.

### FIELD

The disclosure relates generally to a system and method for product placement implemented on a computer system with multiple computing devices.

### BACKGROUND

Consumers are very frequently interested in products and other information they see in video content. It has been very hard to identify and find these products locations and other information relevant to the products for consumers. Most of the time, the consumer will forget about the product or other information or give up their search. This represents a lost opportunity by both content creators and brands who want to be able to market to the consumer. In general, content creators are still heavily relying on income from TV commercials that are skipped by consumers, they suffer from massive piracy and they see their existing business models challenged with content fragmentation. Brands find themselves spending a huge amount of money on commercials that less and less viewers are seeing due to their invasiveness and disruptiveness and struggle to target customers due to the nature of classic media technology.

Further, video on demand and digital video recorders (DVRs) allow viewers to skip commercials and watch their shows without interruption. Today brands have to be inside content and not outside of it. While product placement is a well-known practice it's still limited due to artistic imperatives and doing too many product placements is bad for both content and brands. The return on investment for these product placements is still very hard to measure since there is not a straightforward way to gather conversion rates. Another opportunity that is missed is that, as content is made interactive, the interactive content can be a powerful tool to detect demand trends and consumer interests.

Attempts have been made to try to bridge the gap between a viewer's interest in a piece of information (about a product or about a topic, fact, etc.) he sees in a video and the information related to it. For example, existing systems create second screen applications that display products featured in the video, display tags on a layer on top of the video, or make push notifications on the screen. While synchronization technologies (to synchronize the video and information about a piece of information in the video) are being democratized whether by sound print matching, watermarking, DLNA stacks, HBBTV standards, smart TV apps etc . . . , the ability to provide relevant metadata to consumers has been a challenge. Automation attempts with image recognition and other contextual databases that recommend metadata have been tried to achieve scalability but were not accurate. Other applications simply used second screens to provide a refuge for classic advertisers who have trouble getting the attention of consumers.

Unlike the known systems, for interactive discovery and commerce via video to work viewers should be able to pull information when they are interested in something instead of being interrupted and called to action. To make this possible two interdependent conditions need to be fulfilled at the same time: A high amount of metadata per video and a high amount of videos need to have metadata. This is crucial for giving the power to the viewer. A high amount of videos with a high amount of metadata increases the probability for the viewer to find what he is interested in. Quantity determines the quality of the experience and customer satisfaction therefore a substantial revenue can be generated for production companies.

Limited amount of metadata leads to pushing information to customers which creates big segmentation and behavioral issues that need to be dealt with otherwise the service would be very invasive or intrusive. Automation attempts with image recognition and contextual databases that recommend metadata have been tried to achieve scalability but accuracy was not there. Accuracy is crucial not just for viewer satisfaction, but for business implications. Specifically, brands pay or give services to producers to feature their products and tagging different products that are similar to other brands or wrong products (inaccurate metadata) can create big problems between brands and producers. So even when image recognition produces great results it can lead to major problems.

### BRIEF DESCRIPTION OF THE DRAWINGS

FIG. 1 illustrates an example of an implementation of a cloud computing product placement system;

FIG. 2 illustrates more details of the CMS component of the cloud computing product placement system;

FIG. 3 is a flowchart illustrating a method for product placement using the system of FIG. 1;

FIG. 4 illustrates a second screen experience using the application of the system;

FIG. 5 illustrates a third screen experience using the application of the system;

FIG. 6 illustrates a method for synchronization that may be performed using the system in FIG. 1;

FIG. 7 illustrates a method for gesture control that may be performed on one or more computing devices of the system;

FIG. 8 illustrates more details about the operation of the application that is part of the system;

FIG. 9 illustrates a method for sliding/synchronized frames;

FIG. 10 illustrates a user interface example of the system with a first and second screens;

FIG. 11 illustrates a user interface example of the system with a first screen;

FIG. 12 illustrates a user interface example of the system with a third screen;

FIG. 13 illustrates more details of the operation of the CMS components of the system;

FIG. 14 illustrates a method for managing programs using the CMS components of the system;

FIG. 15 illustrates a tagging process that may be performed using the CMS components of the system;

FIGS. 16 and 17 illustrate examples of the tagging process;

FIG. 18 illustrates a method for grouping products using the CMS components of the system;

FIGS. 19-23 illustrate examples of the user interface during the grouping of products;

FIG. 24 illustrates the types of sources processed using the text treatment tool and the types of information retrieved from the sources;

FIG. 25 illustrates an example of the output of the text treatment system;

FIG. 26 illustrates an overview of the text treatment process and an example of the input into the text treatment tool;

FIG. 27 illustrates more details of the text treatment process of the text treatment tool;

FIGS. 28A and 28B illustrate more details of the treatment process;

FIGS. 29-32 illustrate more details of the annexes of the treatment process;

FIG. 33 illustrates a script supervisor report of the system;

FIG. 34 illustrates more details of the text treatment process of the system;

FIGS. 35 and 36 illustrate more details of a buffer of the system;

FIG. 37 illustrates an image recognition process and framing;

FIGS. 38 and 39 illustrate a product placement process; and

FIG. 40 illustrates a process for tagging products.

### DETAILED DESCRIPTION OF ONE OR MORE EMBODIMENTS

The disclosure is particularly applicable to a product placement system implemented using cloud computing resources as illustrated and described below and it is in this context that the disclosure will be described. It will be appreciated, however, that the system and method has greater utility since it can be implemented in other ways that those disclosed that would be within the scope of the disclosure and the system may be implemented using other computer architectures such as a client server type architecture, a software as a service model and the like. The system and method is described below relates to video content, but it should be understood that the video content may include a piece of video content, a television show, a movie and the like and the system is not limited to any particular type of video content.

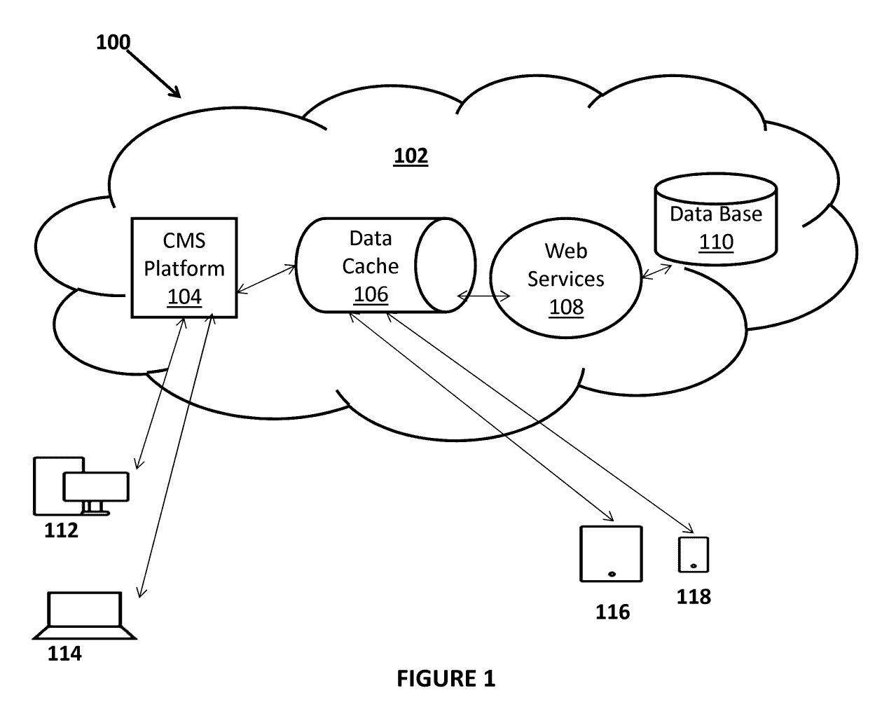

FIG. 1 illustrates an example of an implementation of a cloud computing product placement system 100. The system shown in FIG. 1 and the method implemented by the system may incorporate a consumer application that allows viewers to discover and buy products seen in video content while watching the video or at a later time. The system displays tagged frames that are synchronized with the video content the consumer is watching. The frames are selected from scenes with maximum product exposure and are synchronized with the time line (runtime). Each frame has tags/markers that can be pressed/touched to display information and purchase possibility of the product tagged in the frame. Tags are also used to identify featured celebrities, characters etc. Frames will slide/or appear according to the timeline of the video content. In the system, when information about a product is not available to the consumer, the consumer can make a long press on the item he's interested to add information or request it.

The system adapts to the viewing experience. For example, the consumer can use a feature that allows him to stay focused on the viewing experience, by making a gesture he can capture/mark the frame that features the item he's interested in. He can come back to it later and take the time to discover information and buy the product. The system serves also to detect viewer's interests and market trends. The system can be on multiple devices or a combination of them, it also can be implemented using a browser plug-in.

As shown in FIG. 1, the system may include one or more components that may be implemented using cloud computing resources 102 such as processors, server computers, storage resources and the like. The system 100 may include a CMS platform component 104, a data cache component 106, a web services component 108 and a database component 110 which are interconnected to each other. These components may be known as a back end system. In a software implementation of the system, each components may be a plurality of lines of computer code that may be stored and executed by the cloud computing resources so that one or more processors of the cloud computing resources may be configured to perform the operations and functions of the system and method as described below. In a hardware implementation of the system, each component may be a hardware logic device, a programmable logic device, a microcontroller device and the like that would perform the operations and functions of the system and method as described below.

The system may be used by one or more CMS users using one or more computing devices 112, 114 who coupled to and connect with the CMS platform component 104 and interact with it as described below. In addition, the system may be used by one or more mobile users using one or more mobile computing devices 116, 118 who coupled to and connect with the data cache component 106 and interact with it as described below. Each of the one or more computing devices 112, 114 may be a computing resource that has at least a processor, memory and connectivity circuits that allow the system to interact with the system 100, such as a desktop computer, a terminal device, a laptop computer, a server computer and the like or may be a third party CMS system that interfaces to the system 100. Each of the one or more mobile computing devices 116, 118 may be a mobile computing device that has at least a processor, memory and connectivity circuits that allow the system to interact with the system 100, such as a smartphone like an Apple iPhone, a tablet device and other mobile computing devices. Each of these devices may also have a display device. In one implementation, each mobile computing device and each computing device may execute an application to interface with the system 100. For example, the application may be a browser application or a mobile application.

As shown in FIG. 1, the system 100 has the CMS platform component 104 which consists of systems that perform video treatment and metadata management of the system as described below in more detail.

Video Treatment

Video treatment, that may be performed offline or online, may consist of taking apart the sound track and the video. The video has a plurality of frames and each frame may be stored with a time code. Subtitles can be taken also from the video file. The sound track may be used to produce a sound print that will allow synchronization of metadata with the run time of the video as described in more detail below.

Metadata Management

The process of making professional video content such as movies, series etc. involves a lot of preparation. One part of that preparation is a breakdown that is made by the crew and every department will be responsible of buying, making or borrowing the products/items that will be featured in the video content. This means that information about these products is available from the process of making the video content, but the information is available only in an unorganized or incomplete way.

The CMS platform component 104 allows adding information and an application of the CMS platform component 104 may exist to help buyers and film crew to add information and details. The CMS platform may also have a module that integrates various ecommerce API's. Products can be directly dragged and dropped on items in the frames. If products are not available on ecommerce websites details can still be added and tagged in the frames.

The CMS platform component 104 may perform various operations and functions. For example, the component 104 may perform text analysis and treatment of various information sources including, for example, Script, Call/breakdown sheet/Script supervisor reports and Subtitles. The information extracted from these sources makes the metadata gathering and tagging much more efficient. The output of this operation is a set of organized information by scenes on a time line: Place, Day/Night, Characters, Number of characters, Props products, Time, Camera(s) angle. Information can be completed in the CMS in product section and application version of that module is made to help crew members (especially buyers) to add information on the ground mainly bay taking pictures of products and info related to them, geo-localization and grouping products by scenes characters and sets are a the main features.

The CMS component 104 may also group products for the purpose of facilitating tagging. For example, take a character in a piece of video content who is wearing shoes, pants, shirt and sunglasses. These clothes can be bundled in a group. When finding that character with the same group of products in another segment, it's easier to tag these products again. Extracting looks, decors, styles: Saving groups can help inspire consumers for their purchasing decisions. They can be inspired by the look of their favorite star or the decoration style of a set etc. This is also a cross selling driver. Helping improve the automation of tagging: in the content (especially episodic content). Extract patterns for knowledge database and build semantic rules for the improvement of the image recognition process and methods and feeding a knowledge semantic database that keeps improving image recognition.

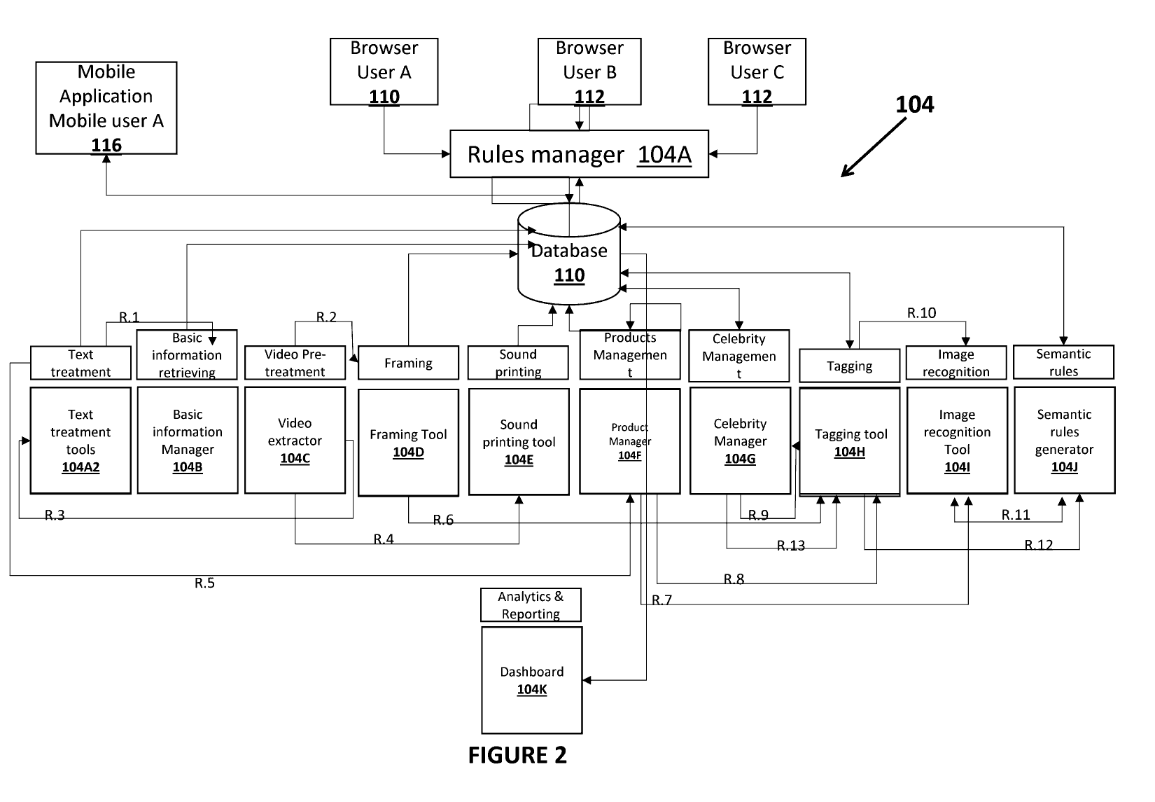

FIG. 2 illustrates more details of the CMS component 104 of the cloud computing product placement system. The CMS component 104 may include the various modules shown in FIG. 2 and each module may be implemented in hardware or software as described above. The CMS component 104 may have a rules manager 104A, a text treatment tool 104A2, a basic information manager 104B, a video extractor 104C, a framing tool 104D, a sound printing tool 104E, a product manager 104F, a celebrity manager 104G, a tagging tool 104H, an image recognition tool 104I, a semantic rule generator 104J and a dashboard 104K that are interconnected and communicate with each other as shown in FIG. 2. As shown by the arrow labeled R1, the text treatment module 104A2 provides some of the basic information from production documents (Script and Break down sheets . . . ): Cast, Character name, Producers etc. to the basic information manager 104B. As shown by arrow R2, the video file (images) is extracted to be framed. Arrow R3 shows that the subtitle file is extracted to be treated in the text treatment module 104A2 to extract dialog and time code of the dialog. Arrow R4 shows that the sound Track is extracted to be sound printed. The sound print allows identification of the video being watched and synchronization of tagged frames with video. Arrow R5 shows that the text treatment module 104A2 can provide products and places information that will be searched and selected in the product management module 104F. Arrow R6 shows that the framing tool 104D compares images in the video and picks a new frame whenever a change is detected. Arrow R7 shows that image recognition techniques (module 104I) may be used to match selected products with their position on frames. Image recognition is also used to find similar products. Arrow R8 shows that the product management module 104F provides the selection of products/information that will be tagged in the frames. Arrow R9 shows that the celebrity management module 104G provides the selection of celebrities that will be tagged in the frames. Grouping products is a sub-module of this module. Arrow R10 shows that image recognition techniques may be applied to identify and tag products that reappear in other frames. Arrow R11 shows that semantic rules contribute to reinforcing the decision making process in image recognition. Arrow R12 shows that a semantic rules module 104J may extract patterns from tags and groups of products. The relations help predict the position of products related to each other. Arrow R13 shows that image recognition techniques may be used to find and match selected celebrities with their position on frames.

Image Recognition Module 104I

The image recognition module consists of a set of tools, methods and processes to automate (progressively) the operation of tagging frames and celebrities (or more generally humans appearing in videos). The following methods and technologies may be used or their equivalent: People counting method that combines face and silhouette detection, (Viola & Johnes), LBP methods, Adaboost (or other machine learning methods), Other Color detection and Shape/edge detection, Tracking (LBP/BS or other), For-ground and back ground detection methods like codebook are other. These methods and techniques are combined with information inputs from Product and celebrities modules and semantic rules.

Video Pre-Treatment

Extraction of audio file, video, subtitles and other information (like poster) if available.

Text Treatment 104A2

While preparing content production companies produce and use documents to organize the production process. The main documents are script, break down sheets, script supervisor reports and other notes they take. The system uses OCR, parsing, contextual comparison and other. Text treatment is used to accelerate data entry to the tagging module.

Semantic Rules Module 104J

The module gathers a set of rules that contribute to the efficiency of image recognition and the tagging process in general. Rules can be added to the knowledge data base by developers, but can also be deduced from tagging and grouping products manually. Product categories and X,Y coordinates are saved and used to find recurring relations. An example of these rules would be: shoes are under pants that are under a belt that are under shirt etc. In a kitchen there's an oven, a mixer etc. The semantic relation can be divided into two large categories mainly: Semantically related to humans or semantically connected to a set. These rules can help recommend and prioritize products to be tagged whether manually, semi-automatically or automatically.

Framing Module 104D

The frames of the video are taken apart and compared for similarities (by color and/or shape recognition) and each images that is not similar to the previous images, according to the sensitivity factor, is saved. The amount and the interval of images depend on the sensitivity that is applied for the color and shape recognition) each saved image has a unique name. At the same time we store in the database the reference of each frame/time code. This tells us exactly at what time what frame appears in the program. Other methods like Codebook can be used for framing: (consider first frame as background when a for-ground is detected the frame is selected, New background detected frame is selected etc.

Sound Printing (Synchronization) Module 104E

Sound printing is a synchronization method: it consists of creating a sound print from the audio file of the program (video content or audio content). The sound print is used to identify the content and track run time. This module can be replaced by other technologies or a combination of them depending on the devices that consumers use to get content ID and run time. Other technologies that can be used for synchronization of metadata display on the same device or by connecting more than one device may include sound watermarking, Image recognition, connected (set top box, game console, DVR, DVD, smart TV etc.) to computing device like a phone or a tablet . . . by Dlna stack, blutooth, infra red, wifi etc., HBBTV, EPG . . . Or with an proprietary video player.

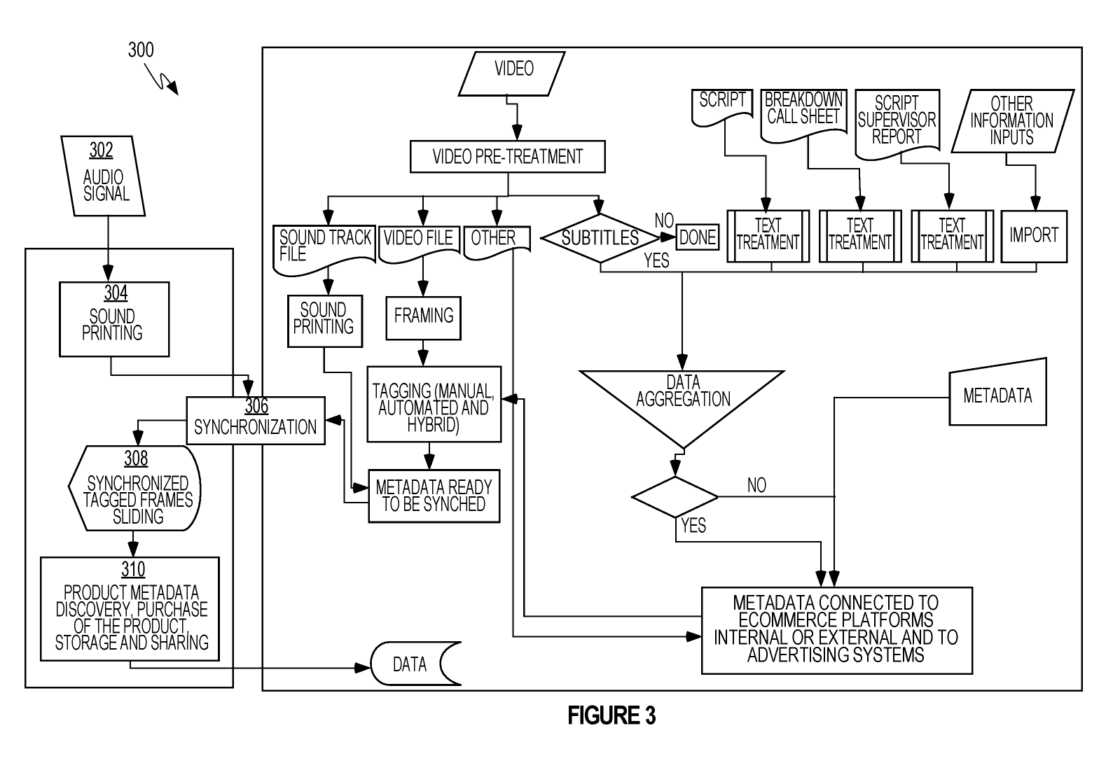

FIG. 3 is a flowchart illustrating a method 300 for product placement using the system of FIG. 1 in which an audio signal 302 and a video signal may be synchronized 306. For the audio signal 302, the method performs a sound printing process 304 (such as by the sound printing tool 104E shown in FIG. 2) and the sound printed audio file is synchronized using a synchronization process 306. From the synchronization process, the method generates sliding synchronized tagged frames 308 that may be used as metadata for a product discovery, product purchase 310 and stored in the database shown in FIG. 1.

For the video, video pre-treatment is performed (using the video extractor component 104C) that generates a sound track, video file, other data and subtitles. For the video, there may be other forms of inputs, like scripts and the like, that undergo a text processing process (performed by the text treatment component 104A2) that may generate the metadata for the video. In addition, the sound track file of the video may have a sound printing process 304 (such as by the sound printing tool 104E shown in FIG. 2) performed and the video file may have a framing process (such as by using the framing tool 104D in FIG. 2) performed. Tagging of the various video data may be performed (such as by the tagging tool 104H in FIG. 2) and the resulting metadata may then be synched through the synchronization process.

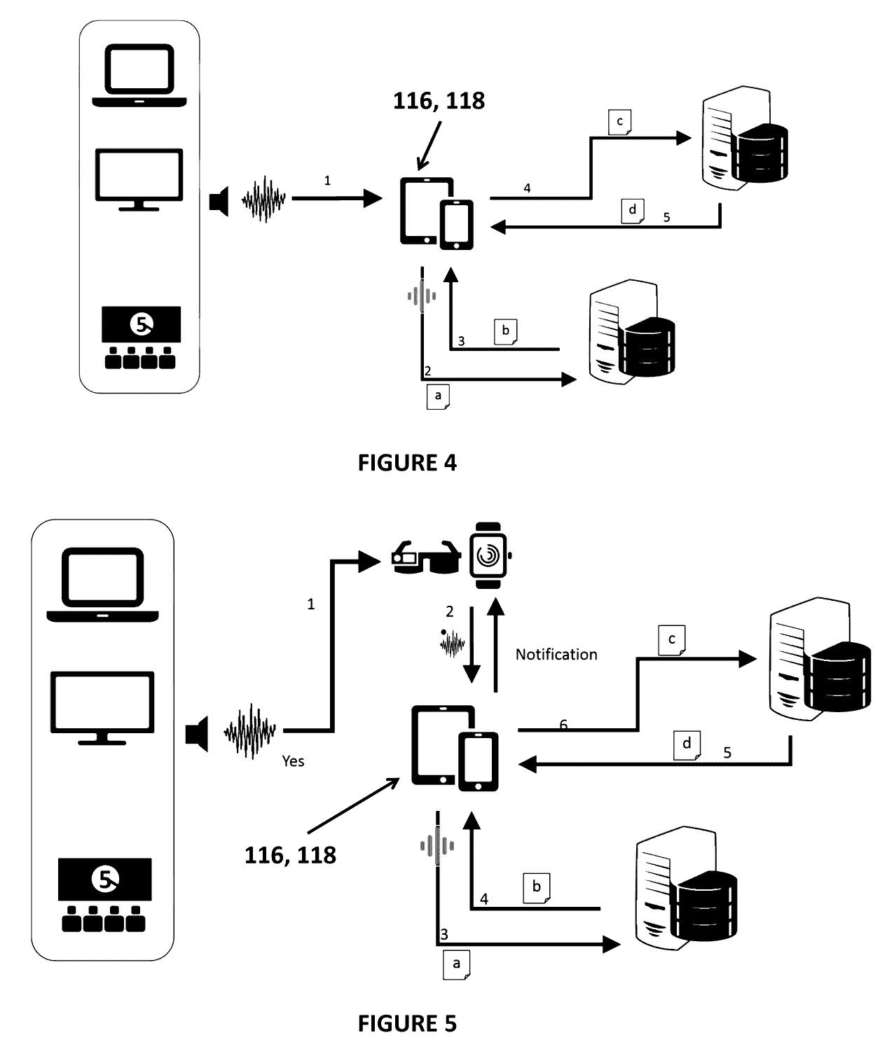

FIG. 4 illustrates a second screen experience using the application of the system. The second screen may appear on the mobile computing devices 116, 188 shown in FIG. 1. As shown in FIG. 4, the second screen device receives (1) the sound print generation (2) from the system as well as the sound print fetching (3). The program (video content) ID (4) is sent to system components and the metadata of the Program from the system (5) (general information and synchronized tagged frames with products) may be sent to the second screen device. The sound print (a), the program ID (b), the program ID (c) and the program metadata (basic information, synced frames with tags) (d) are shown in FIG. 4.

FIG. 5 illustrates a third screen experience using the application of the system in which the first screen device may be a wearable computing device, such as a pair of glasses having an embedded computer such as Google® Glass or a smart watch device such as the Android based smart watch or Apple watch, etc., as shown and a second device that may be mobile computing devices 116, 188 shown in FIG. 1. The first screen device may be used by the user to identify and capture a moment when an interesting item appears in the piece of content. In the three screen example shown in FIG. 5, the first screen device receives (1) the audio signal and the audio signal may be sent to second screen device (2) (if first screen can't generate a sound print). Then, the second screen device receives the sound print generation (3) from the system as well as the sound print fetching (4). The program (video content) ID (5) is sent to system components and the metadata of the Program from the system (6) (general information and synchronized tagged frames with products are sent to device, the frame with the run time of interest is marked and saved) may be sent to the second screen device. Then, a notification may be sent from the second device to the first device (7). The sound print (a), the program ID (b), the program ID (c) and the program metadata (basic information, synced frames with tags) (d) are shown in FIG. 5.

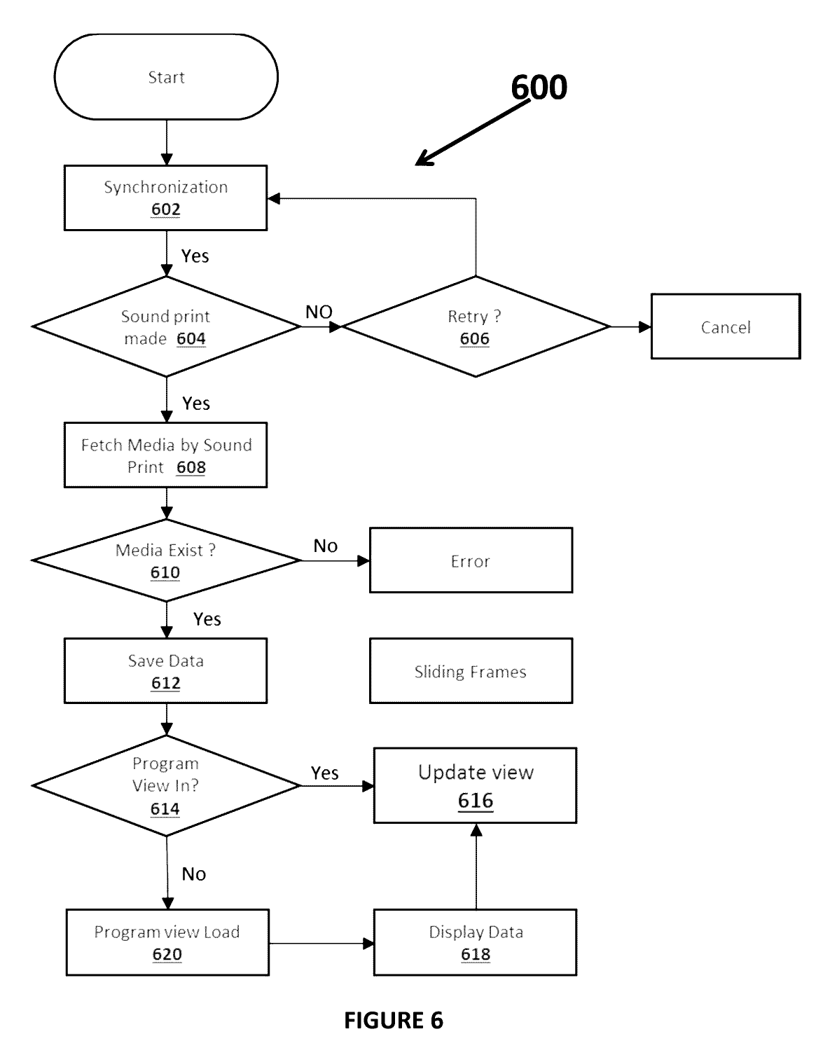

FIG. 6 illustrates a method 600 for synchronization that may be performed using the system in FIG. 1. During the method, a synchronization between the video/audio and the metadata may be performed 602 and the method may determine if a sound print is made (604). If the sound print has not been made, then the method retries the synchronization. If the sound print was made, the method may fetch media based on the sound print (608). The method may then determine if the media exists (610) and generate an error if the media does not exist. If the media exists, the method may save the data (612) and determine if the program view is already in loaded in the first and second device (614) and update the view (616) if the program view is already in. If the program view is not in the device, the program view is loaded to the device (620) and the data is displayed (618).

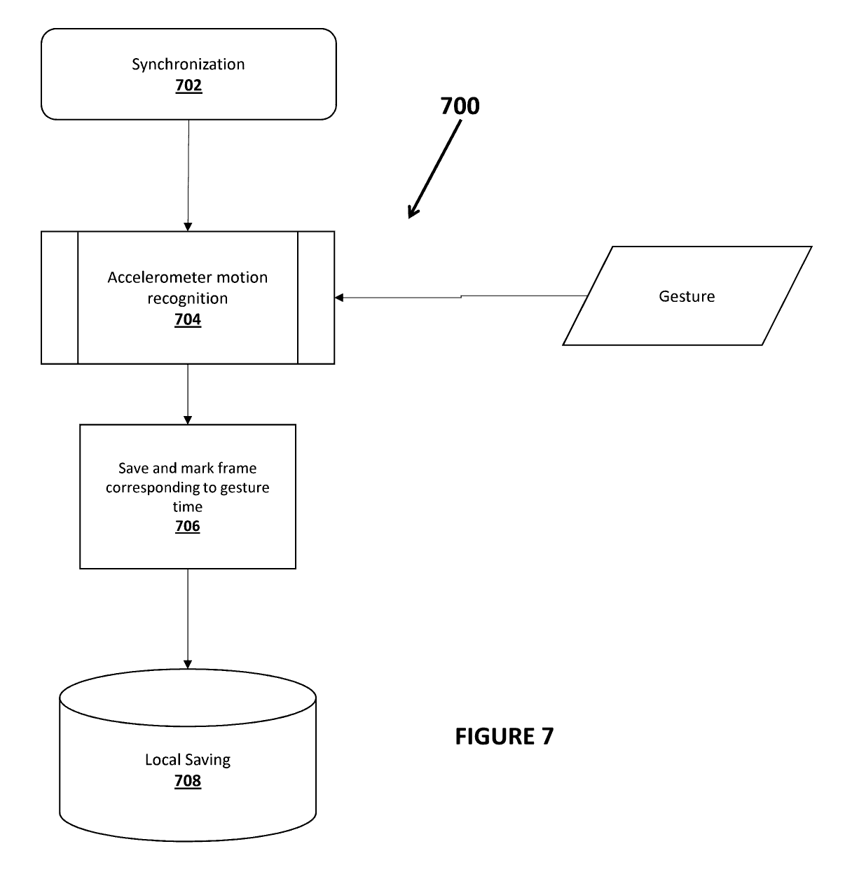

FIG. 7 illustrates a method 700 for gesture control that may be performed on one or more computing devices of the system. In the method, once the synchronization process (702) described above has occurred, a gesture of the user of the device may be recognized (704) by an motion or orientation sensor, such as an accelerometer, in the device. The method may also be performed using other motion or orientation sensors as well. The device, in response to the gesture recognition, may make and save the frame of the video (706) based on the time stamp of the gesture (when the gesture occurred so that the gesture can be correlated to a particular frame of the video). The device may then save the frame (708) so that the product placement information in that frame may be displayed later to the user of the device.

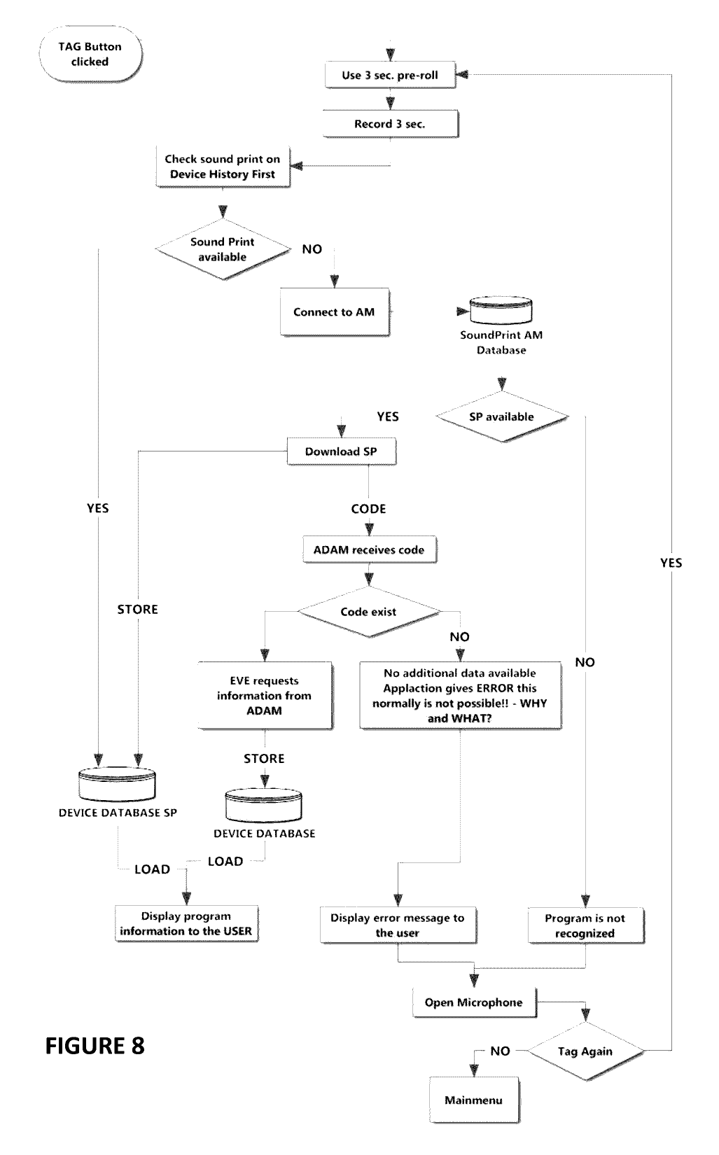

FIG. 8 illustrates more details about the operation 800 of the application that is part of the system. In this diagram, Adam refers to the CMS system and its components and Eve refers to application that is executed by the computing devices.

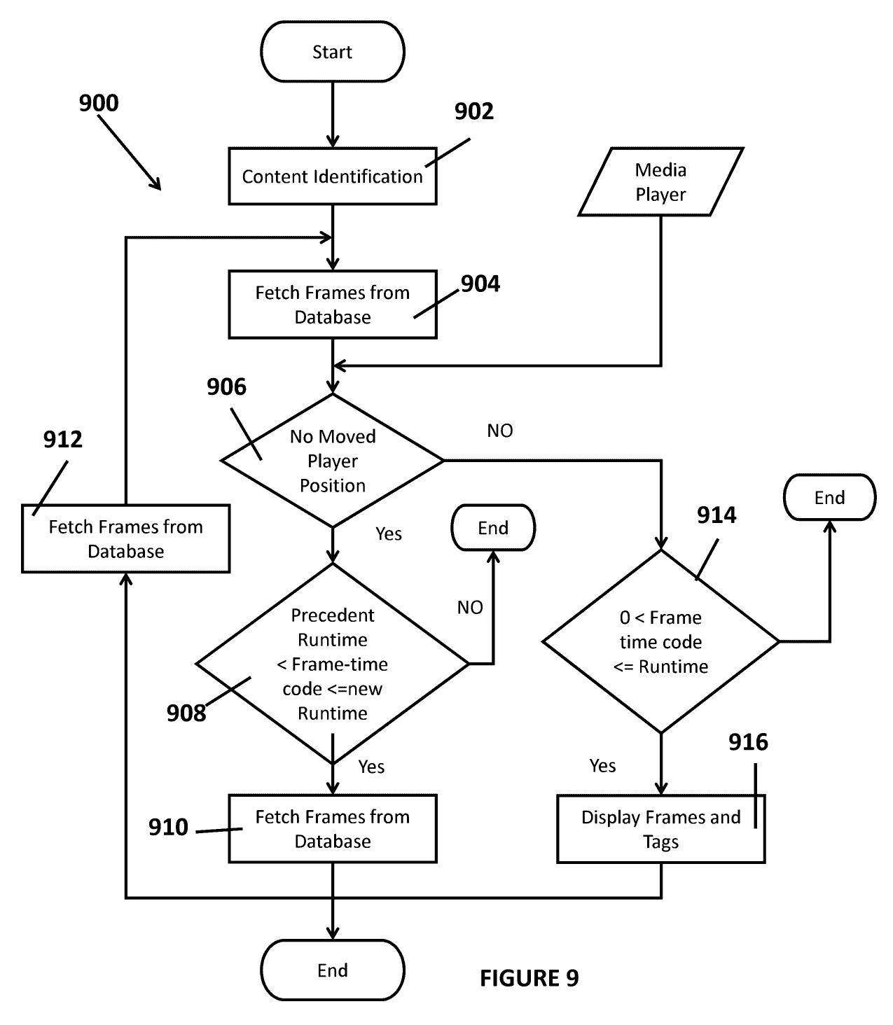

FIG. 9 illustrates a method 900 for sliding/synchronized frames that may be performed by the application that is executed by the computing devices. The method may perform a content identification process 902 is which the method detects (media video content/program) and run time. For example, the TV show Suits season 2 episode2 min 23:40 sec. Thus, the content identification allows the system and application to fetch frames (904) by runtime/time code from the database of the system.

The method may then determine if the player position has moved (906). If the player position has moved, the method may set the Precedent Runtime<Frame-time code<=new Runtime (908) and then fetch the frames from the database (910). Thus, the frame with runtime (time code) equal or inferior to the run time of the video will be displayed plus precedent frames. If a change in the run time of the video display frame with runtime will be displayed plus missing precedent frames.

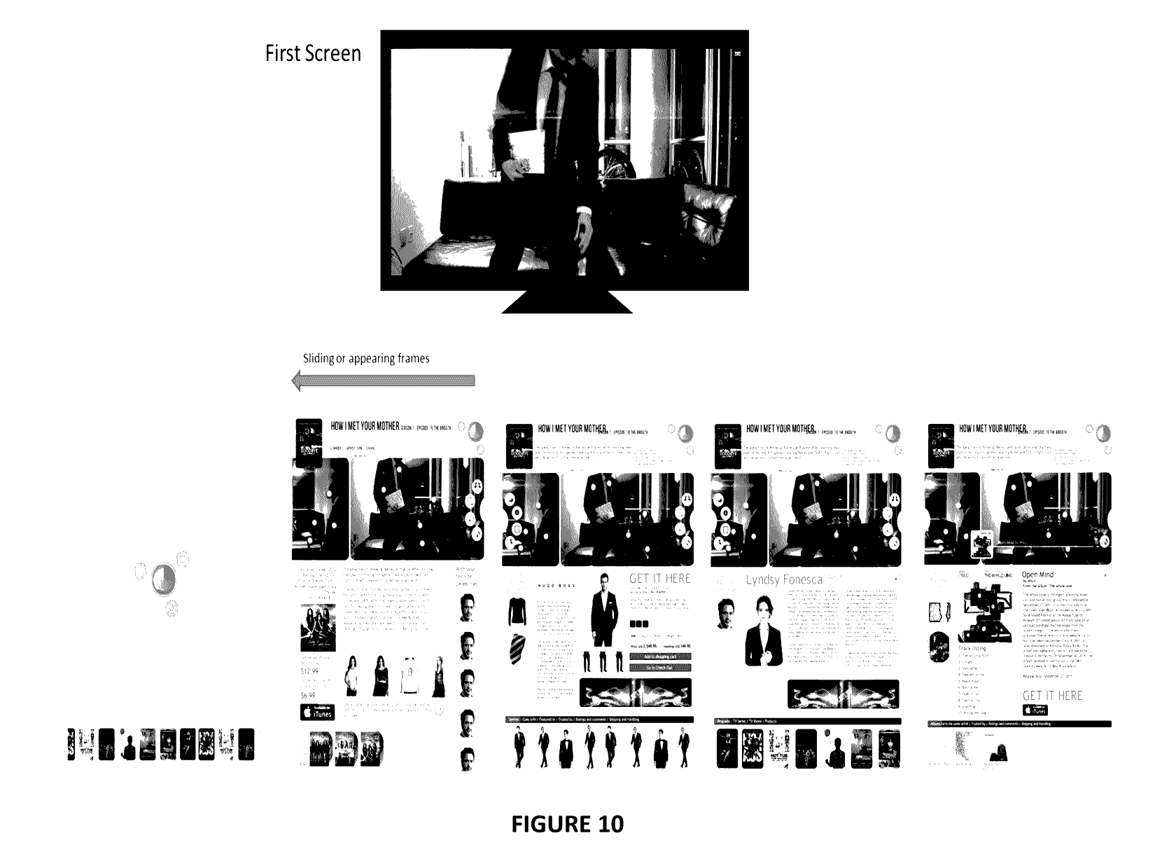

If the player position has not moved, then the method may set 0<Frame time code<=Runtime (914) and display the frames and the tags (916). The sound print tracking during the method is a continuous (repeated) process that allows the displaying of the right frame (frame with runtime (time code) equal or inferior to the run time of the video. In the method, the frames may slide or appear or disappear as shown in the user interface examples described below. The method in FIG. 9 can be applied to 1st screen, 2nd screen (as shown for example in FIG. 10), 3 screen experiences or any other combination of devices.

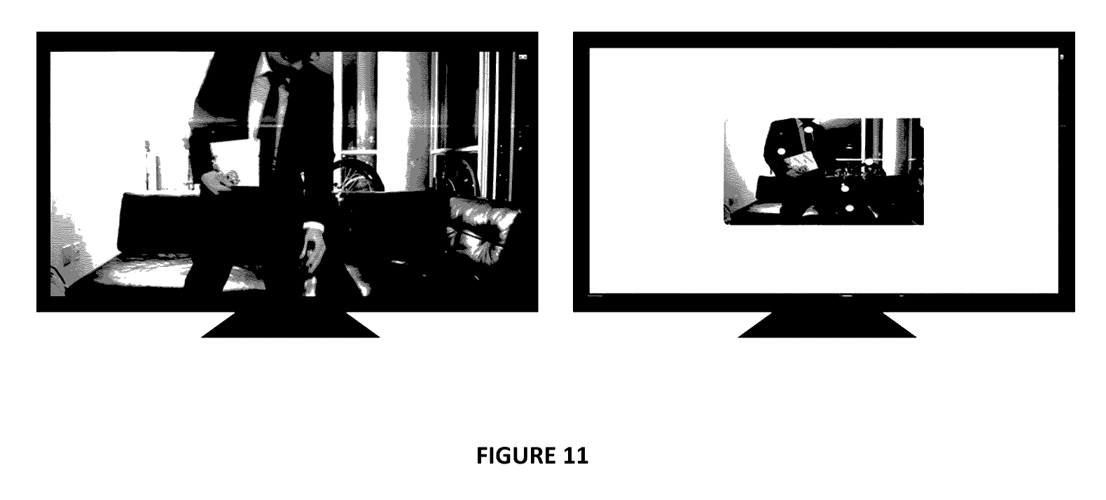

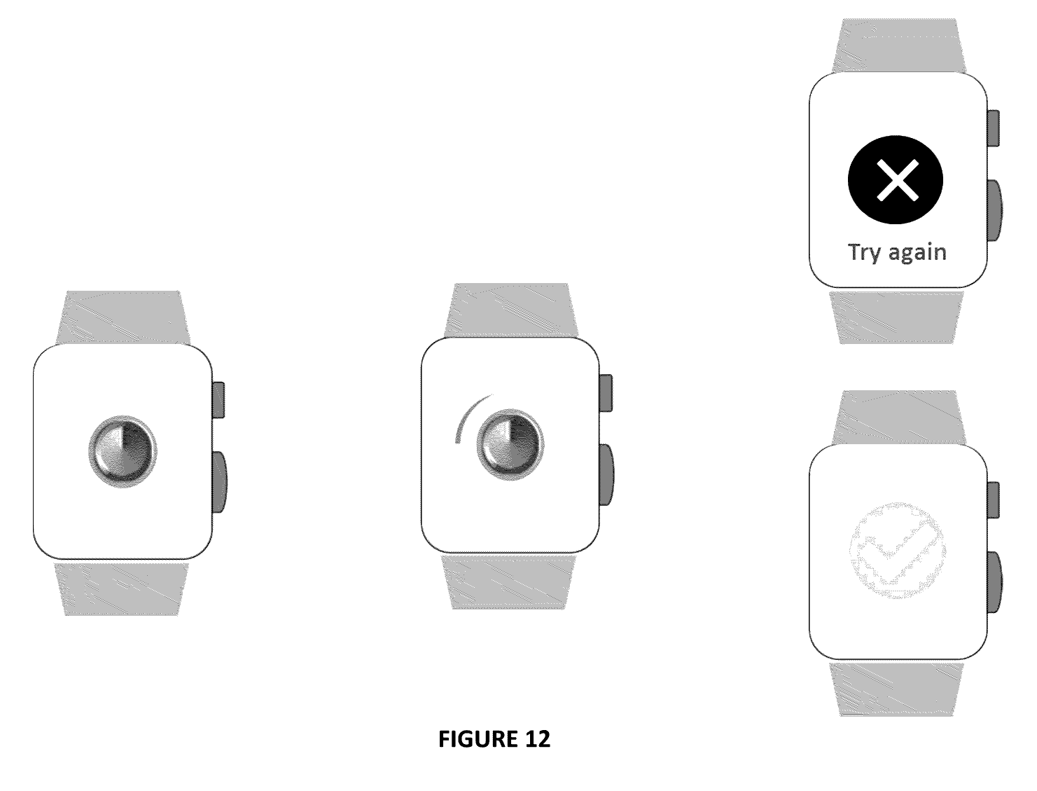

FIG. 10 illustrates a user interface example of the system with a first and second screens in which the first screen is the display showing the content (such as, for example, a television, monitor, computer display and the like) and the second screen is the display screen of a computing device. In the user interface, sliding or appearing/disappearing user interface screens are shown to the user that are synchronized with the content/frames on the first screen. As shown, the user interface screens of the second display may show information about the products shown in the content or information about the content. FIG. 11 illustrates a user interface example of the system with a first screen in which the information about the content is displayed on the same screen as shown. FIG. 12 illustrates a user interface example of the system with a third screen (a smartwatch example in FIG. 12) in which the third screen may display various information of the system as shown.

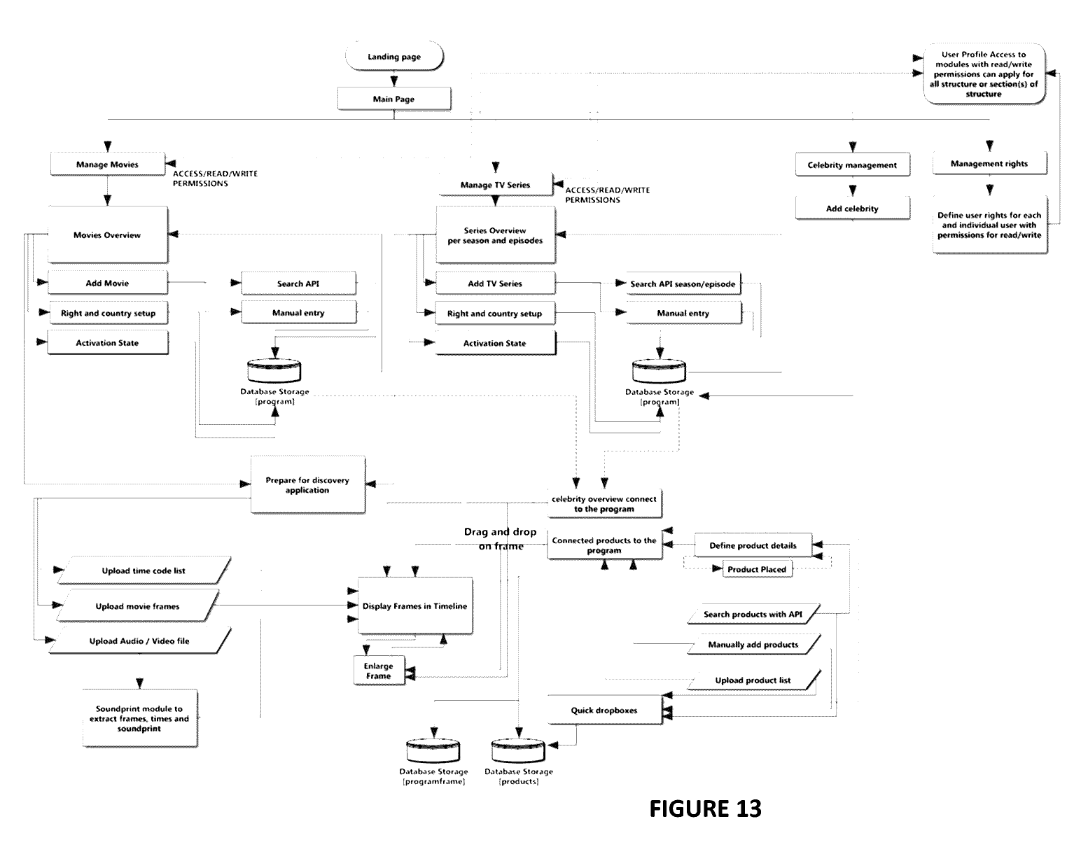

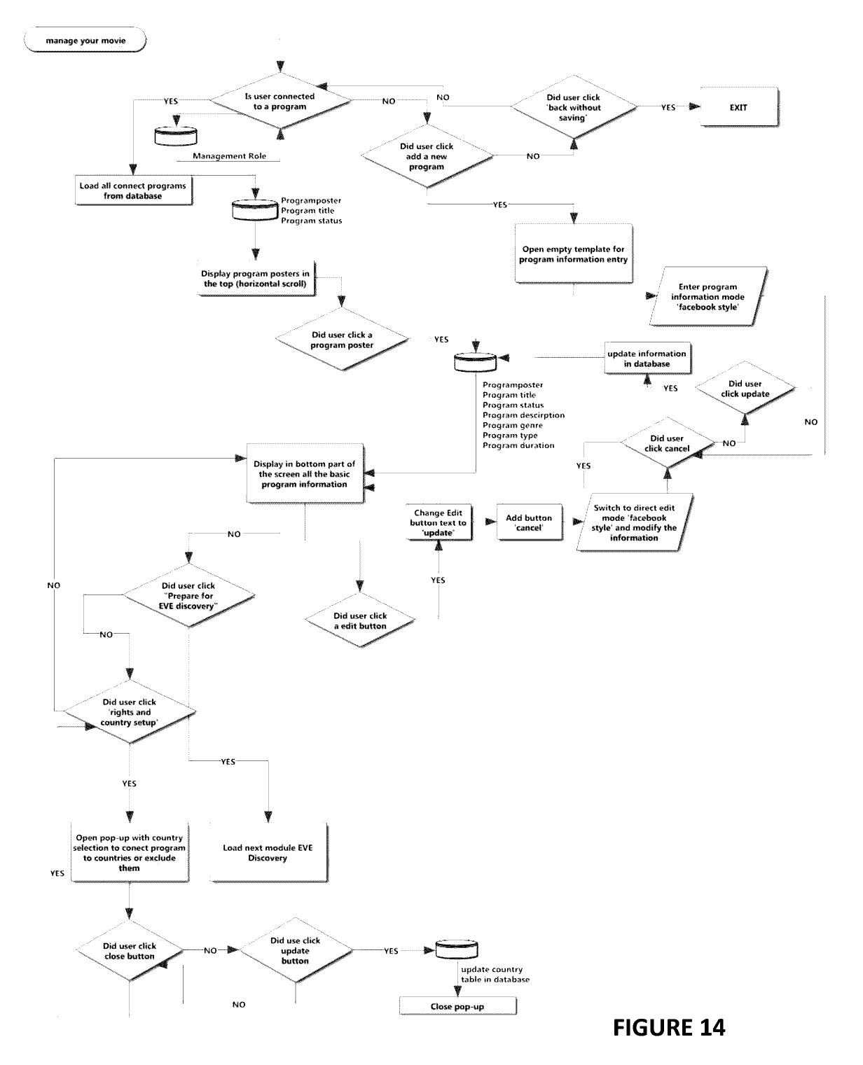

FIG. 13 illustrates more details of the operation of the CMS components of the system and FIG. 14 illustrates a method for managing programs using the CMS components of the system. This part of the system operates to add a new piece of content, such as a movie, into the system and to provide the access rights for the particular piece of content. To add a movie, the user must have management rights to be able to see the movie if the user is not connected to any movies (in the case someone did not give the user privileges). The user can also add a movie (program) and he will be the owner of the program and the user can connect others to the program. If the user clicks on a connect program, the user can have several rights such as prepare for discovery, country and rights setup etc. these options can also be disabled by the rights owner but only if it concerns a connected program. In the system, the user that adds the program is the owner with all ‘administrator’ rights and possible to add others to the program and specify specific rights for each and every user.

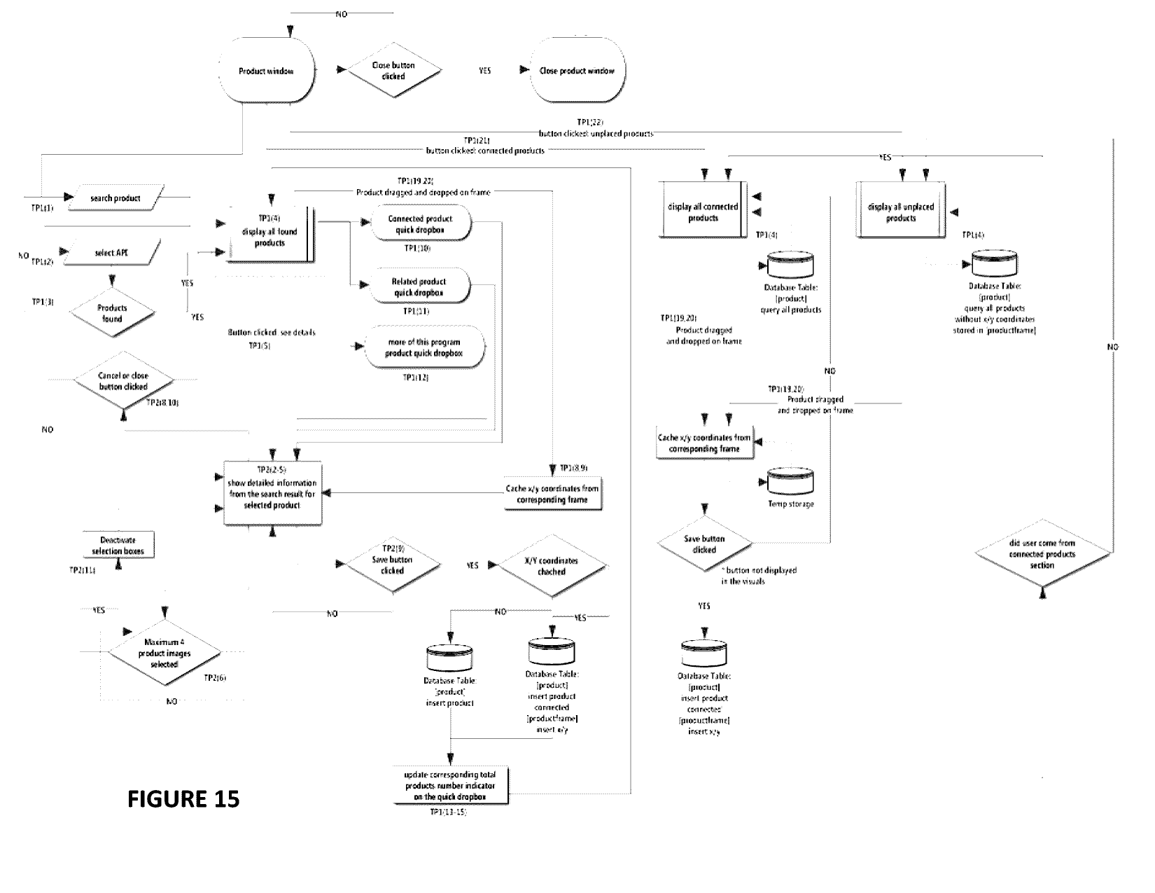

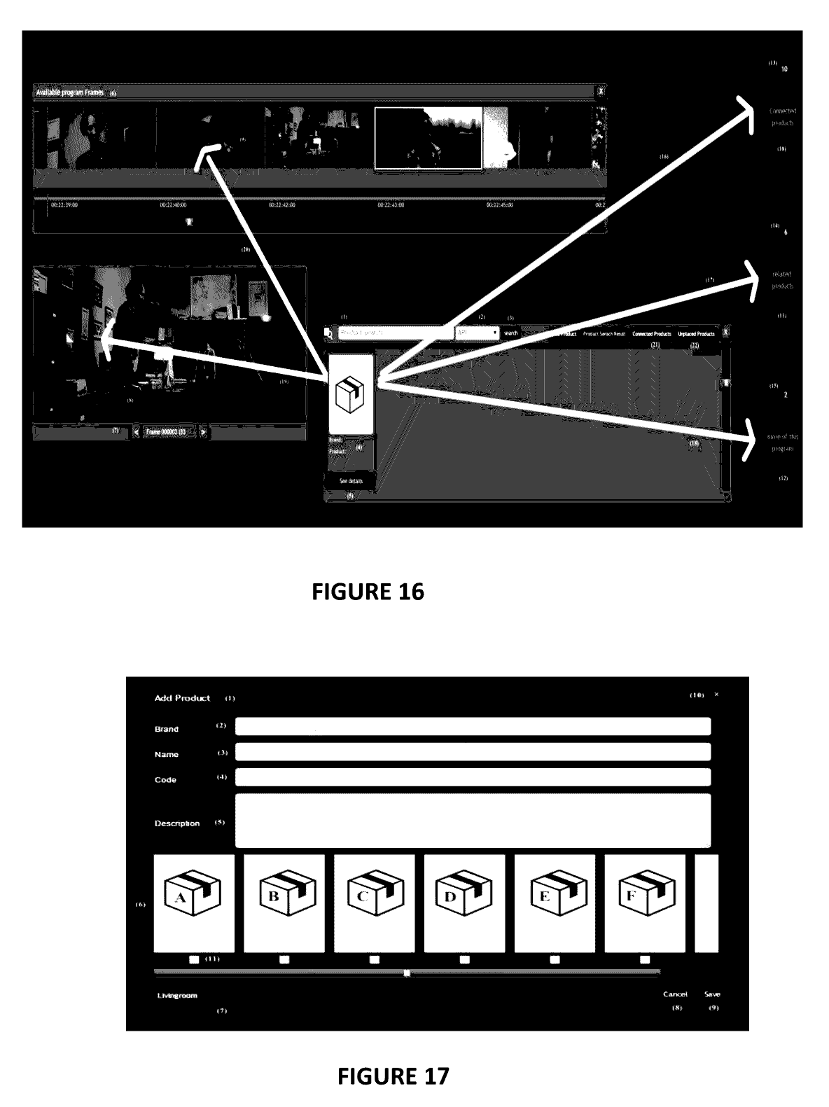

FIG. 15 illustrates a tagging process that may be performed using the CMS components of the system and FIGS. 16 and 17 illustrate examples of the tagging process. During the tagging process, the user may enter a product search [FIG. 16(1)] and selects an API [FIG. 16(2)] to search in and clicks the search button [FIG. 16(3)]. When products are found with the entered criteria of the result may be presented to the user with a product summary [FIG. 16(4)] consisting out of a product image, the brand of the product and a short description. If the user want to see more details about a product, the user can click the See details button [FIG. 16(5)] and a modal [FIG. 17] is presented to the user with additional product details. The user can drag the product [FIG. 16(16-20)] to various sections in the screen; the quick to add dropboxes [FIG. 16(10-12)], directly on a frame [FIG. 16(9)] in the available program frames window [FIG. 16(6)] or directly on the enlarged frame [FIG. 16(8)] of the enlarged frame window [FIG. 16(7)]. When the product is dropped on one of the quick dropboxes [FIG. 16(10-12)] the product opens a modal [FIG. 17] with the details information, the user selected the images [FIG. 17(6) that the user thinks that best represent the product and the product is saved [FIG. 17(9)] in the database. The corresponding counter [FIG. 16(13-15)] of the selected quick Dropbox changes into the right number of all the products that are available in the database. If a product is dragged [FIG. 16(19-20)] directly on a frame the system will display the product detail modal after saving the dropbox counter of Connected Products [FIG. 16(13)] shows the updated number of connected products inside the database. Within the product details, the user is able to overwrite the information that comes from the API output such as the Brand [FIG. 17(2)], the product name [FIG. 17(3)], the product code [FIG. 17(3)] and the product description [FIG. 17(4). If the user clicks on the button cancel [FIG. 17(8)] or on the button close [FIG. 17(10)] no information is saved in the database. If user clicks the button connected products [FIG. 16(21)] a list of all the products that is stored and connected to the selected program is presented to the user. The user can then follow the same steps for dragging a product on a frame [FIG. 16(19,20)] with the exception that the product details screen is not presented but the x/y coordinates are cached in a temporary database. If the user clicks the general save button (not displayed in a visual) the information is inserted into the database table ‘programframe’ and the cache of the system is emptied. The same procedure applies for unplaced products [FIG. 16(22)] with the difference that is only shows products that have no previous entered x/y coordinates in the ‘programframe’ table and there for will not appear in a frame or the final product.

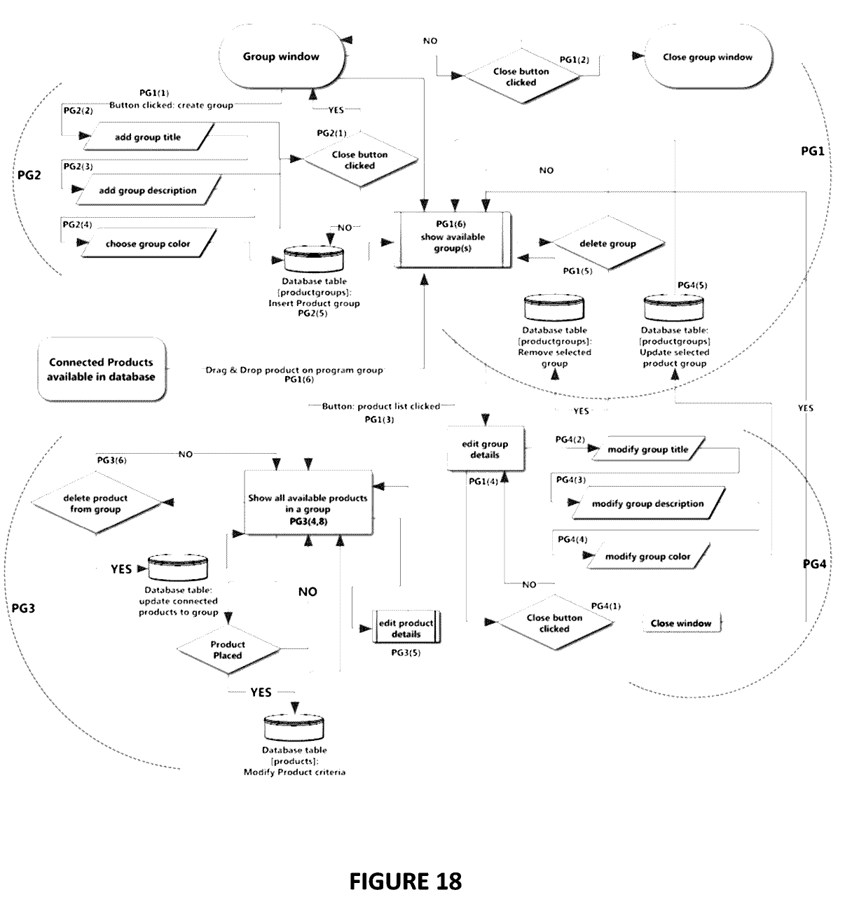

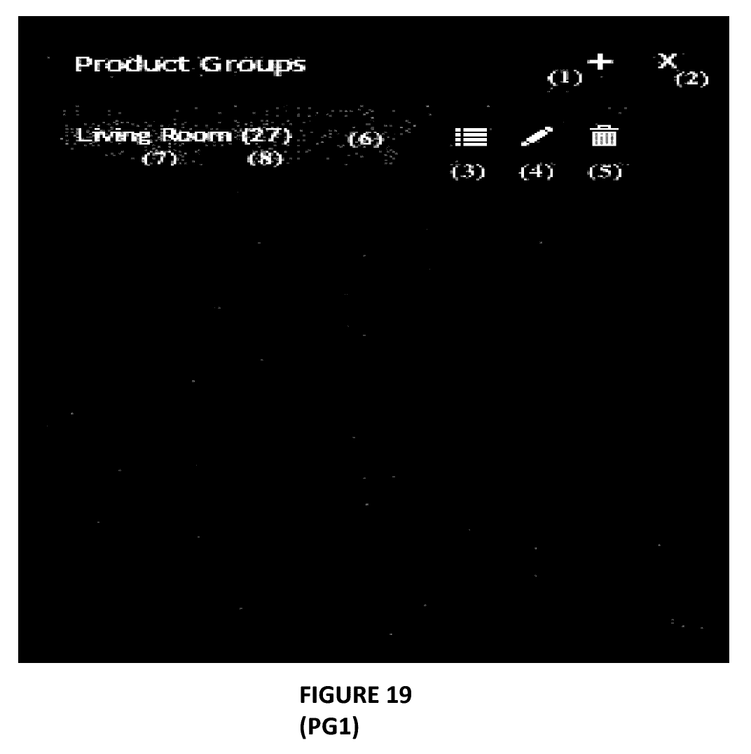

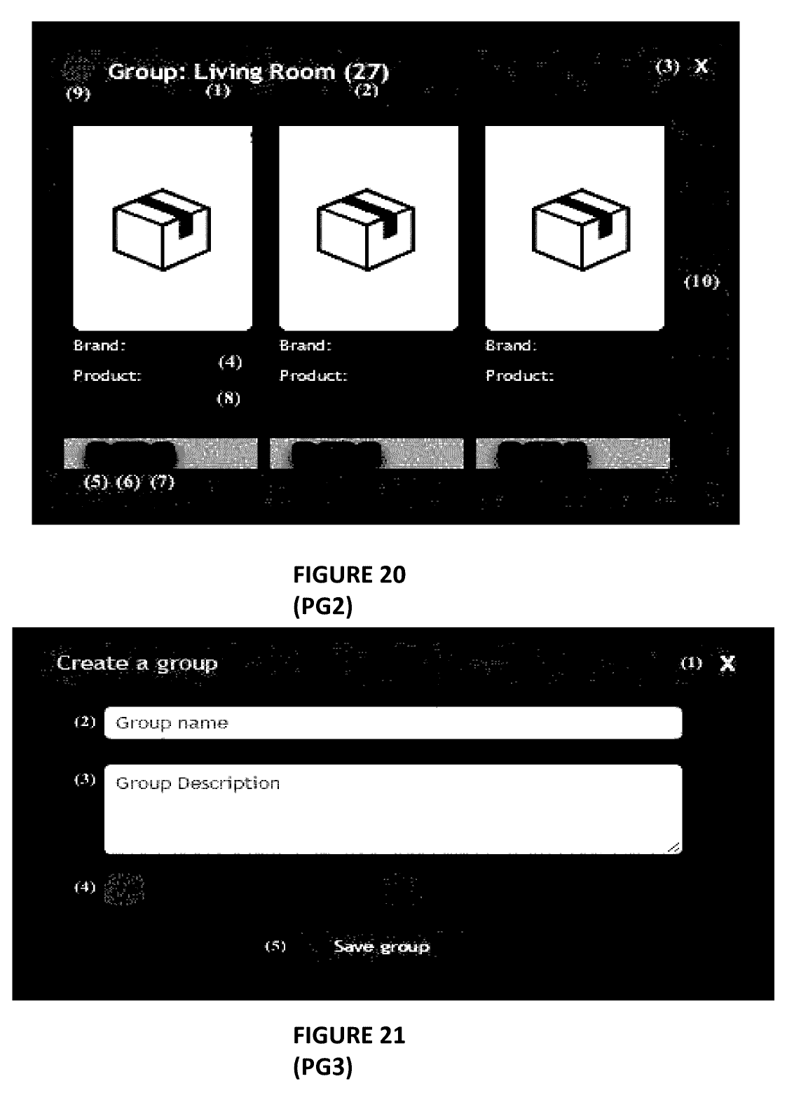

FIG. 18 illustrates a method for grouping products using the CMS components of the system and FIGS. 19-23 illustrate examples of the user interface during the grouping of products. During the grouping of products process, the user clicks the ‘CREATE GROUP’ Button [FIG. 19 (PG1)(1)] and the create group details [FIG. 20(PG2)] pop-up becomes visible. In the user interface shown in FIG. 20(PG2), the user may enter the group name [FIG. 20(PG2)(2)], a small description [FIG. 20(PG2)(3)], and has the option to select a group color [FIG. 20(PG2)(4)]. By clicking the save group button ([FIG. 20(PG2)(5)] the group is created in the database. The close button [FIG. 20(PG2)(1)] in the top bar closes the group and the process is cancelled. The number of groups in the system is unlimited.

In the system, once the group information is saved, the group [FIG. 19(PG1)(6)] becomes visible in the overview, the group has a background color as selected in the create group section [FIG. 20(PG2)(4)] and has the group name as added in the group name box [FIG. 20(PG2)(2)]. To add a product to a group, the user may drag from a product container or product search result container directly on the product group [FIG. 19(PG1)(6)]. If the product is not already registered in the database, the Add Product container is opened to modify the product details. By clicking the product list button [FIG. 19(PG1)(3)], the system shows the contents of the group (aka the products) in a new window [FIG. 21(PG3)].

In the new window [FIG. 21(PG3)], the system may display the same name [FIG. 21(PG3)(1)], the group color and the number of products in the group [FIG. 21(PG3)(2)]. If the window is not big enough to show all the products, a scroll bar is presented to the user on the right side [FIG. 21(PG3)(10)]. The group content consists of the product [FIG. 21(PG3)(8)] and brand [FIG. 21(PG3)(4)] information and three buttons to control the information. An edit button [FIG. 21(PG3)(5)] lets the user see details of the product and change it which opens a product details window. A delete button [FIG. 21(PG3)(6)] removes the product from the group, not from the program and a Product Placement button [FIG. 21(PG3)(7)] allows the user to change to a special marker image. The user can close this window with the close button [FIG. 19(PG1)(3)].

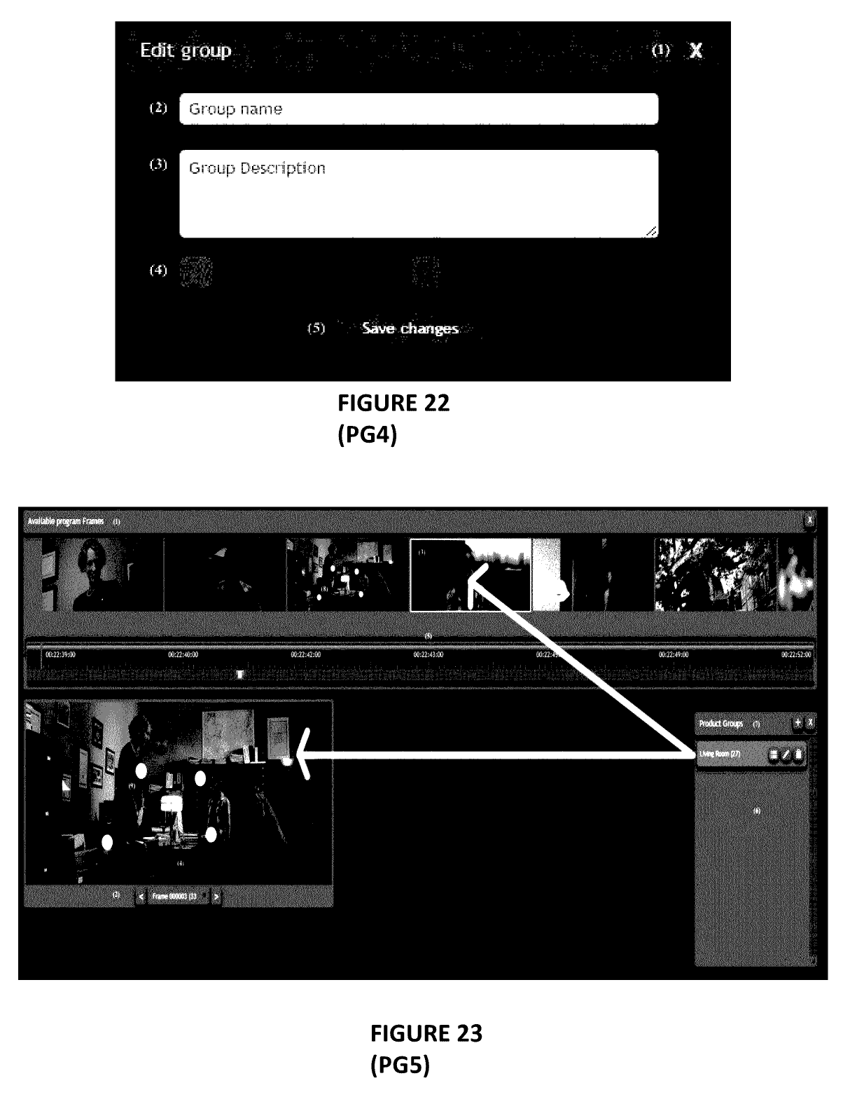

It is possible to drag one product from a group directly on a program frame [FIG. 21(PG5)(3)] or the enlarged frame [FIG. 23(PG5)(4)] or a single marker [FIG. 23(PG5)(9)] and [FIG. 23(PG5)(8)] are placed on top of the frame to indicate its position. The Product group window can hold an unlimited amount of groups [FIG. 19(PG1)(6)]. The list of groups can be sorted over the vertical axis with a simple drag-and-drop action. New groups are always added in the top of the list. By clicking on the edit button [FIG. 19(PG1)(4)], the window edit group [FIG. 22(PG4)] is loaded and gives the user the option to change the characteristics of the group. The group name [FIG. 22(PG4)(2)] is loaded from the database as such as the group description [FIG. 22(PG4)(3)] and the group color [FIG. 22(PG4)(4)]. By clicking the save changes button [FIG. 22(PG4)(5)], the changes are saved in the database and clicking the close button [FIG. 22(PG4)(1)] will close the window and no changes are saved in the database. By clicking the delete button [FIG. 19(PG1)(5)], the user can delete the complete group from the database, the products that are inside the group are not deleted. It is possible to drag a complete group [FIG. 19(PG1)(6)] directly on a frame [FIG. 23(PG5)(3)] or on the enlarged frame [FIG. 23(PG5)(4)]. In the system, all the products inside of the group [FIG. 21(PG3)] may be placed on the frame [FIG. 23(PG5)(3)] and the corresponding enlarged frame [FIG. 23(PG5)(4)] and vice versa. It is also possible to tag products in the frames and then group tags by selecting them with the mouse (or with a keyboard, multi touch or sliding touch on a touch screen.

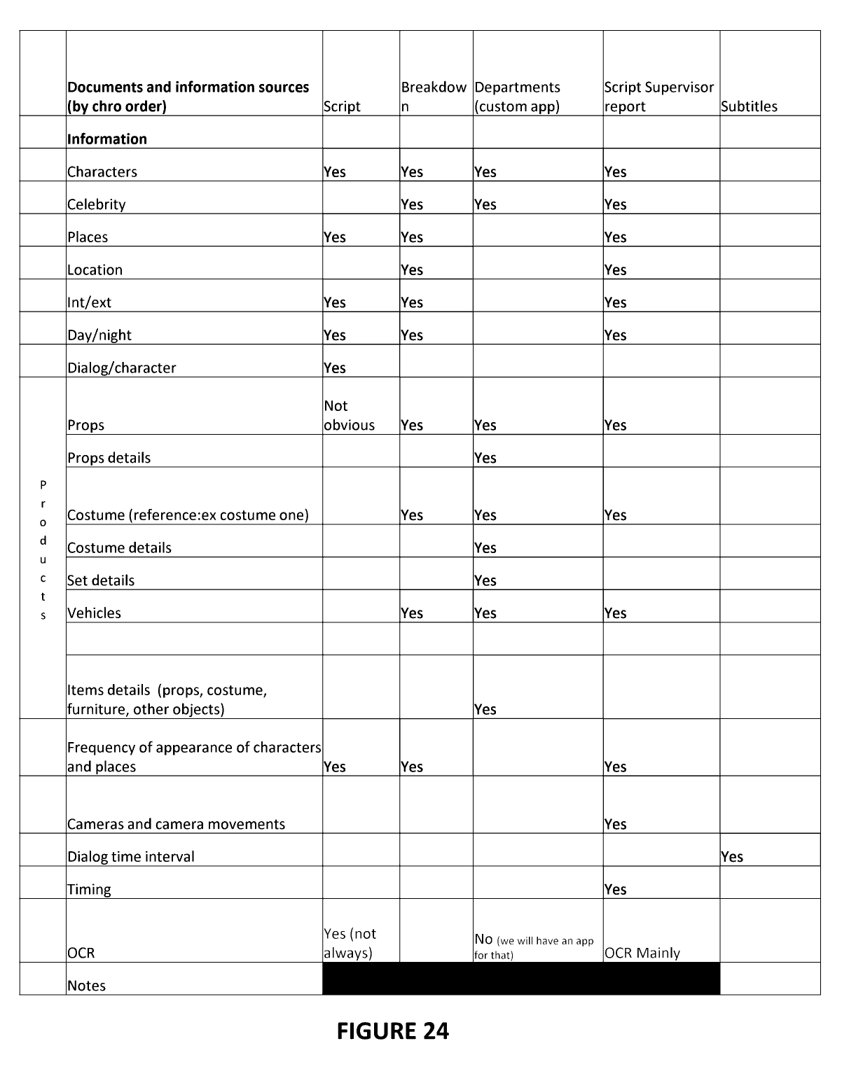

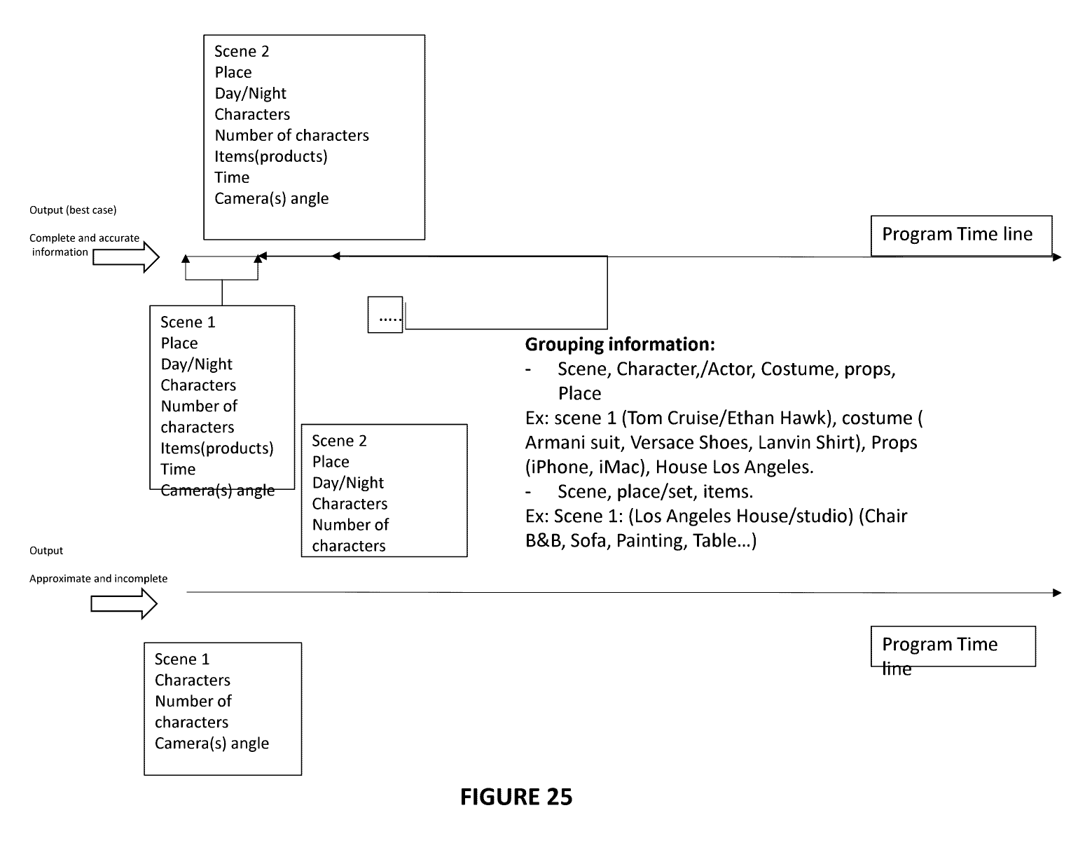

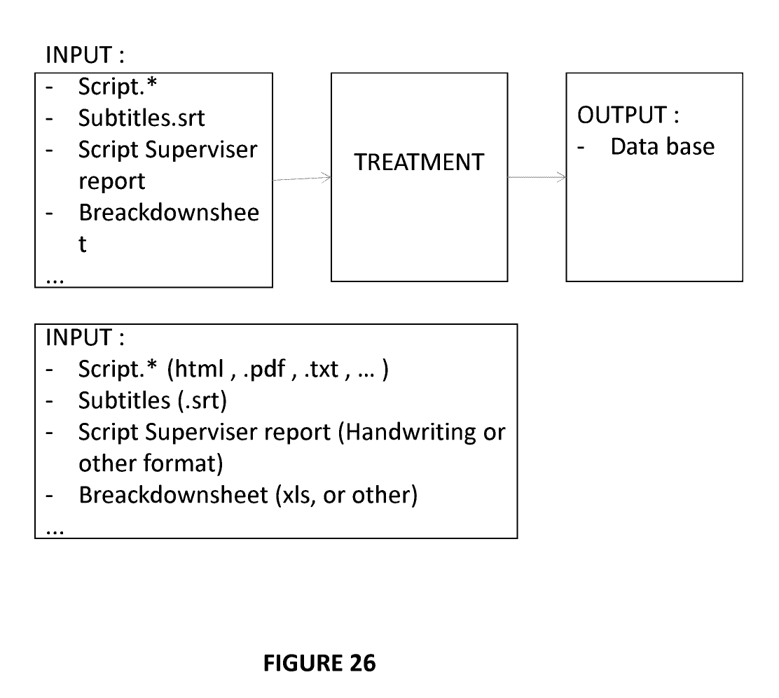

FIG. 24 illustrates the types of sources processed using the text treatment tool and the types of information retrieved from the sources and FIG. 25 illustrates an example of the output of the text treatment system. In the system, recommendations based on available information if information is not available recommendation based on script only. FIG. 25 shows two examples of the information for the frames extracted by the text treatment tool. Furthermore, FIG. 26 illustrates an overview of the text treatment process and an example of the input into the text treatment tool.

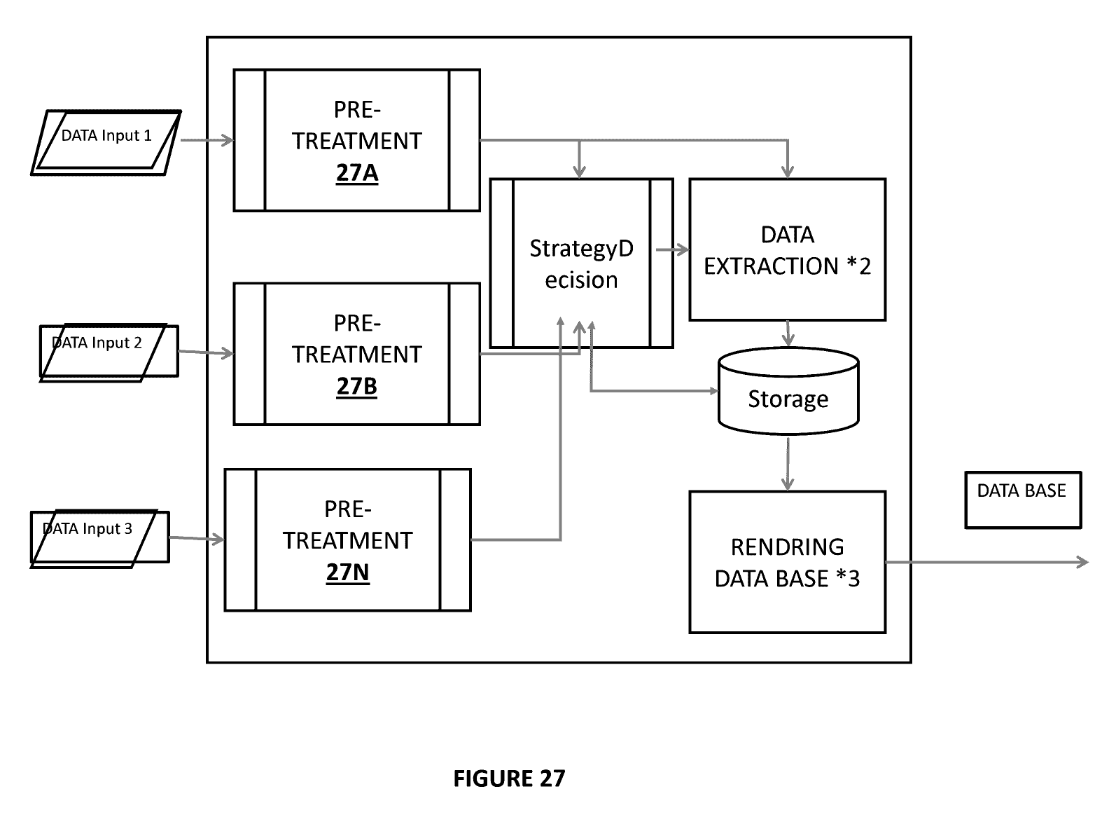

FIG. 27 illustrates more details of the text treatment process of the text treatment tool. As shown, each type of input needs a specific type of pre-treatment (such as text conversion, cleaning, tagging, classification . . . ) process 27A, . . . , 27N in the example in FIG. 27. The output from each pre-treatment may be fed into a strategy decision block and a data extraction block. The strategy decision block contains a set of rules to process each pre-treated source data while the data extraction is the process of extracting needed information from DATA input given the adequate strategy (the set of rules in the strategy decision block). The text treatment process may also have a rendering database that puts all of the gathered information in a database of the system.

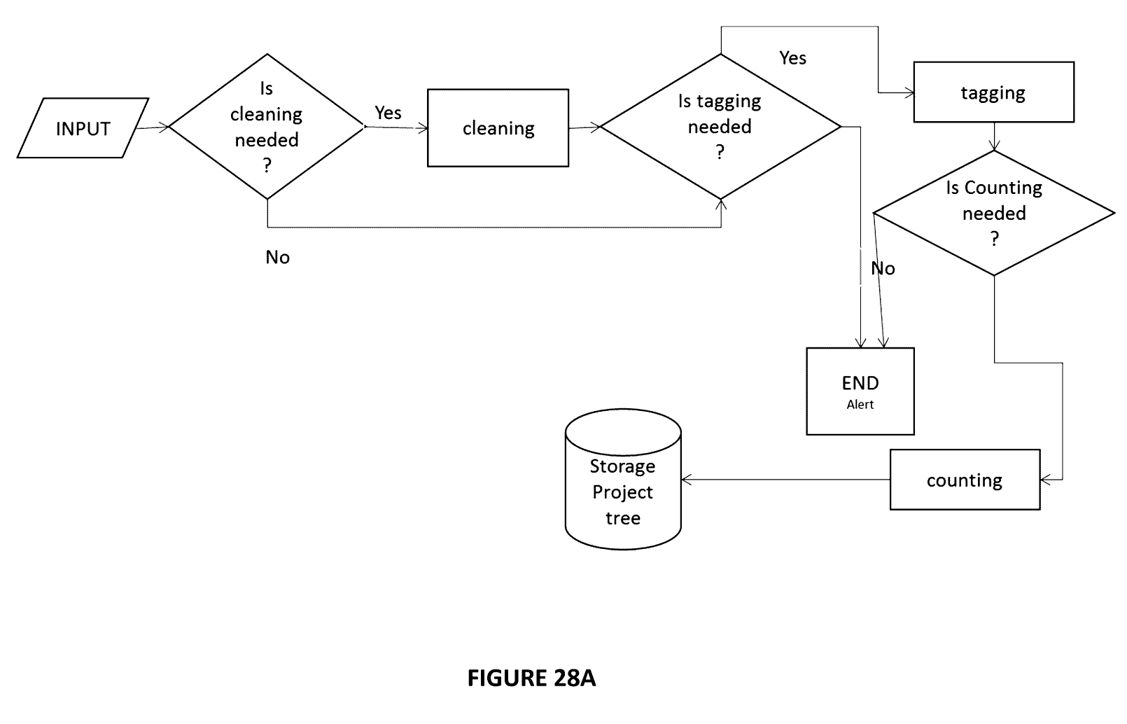

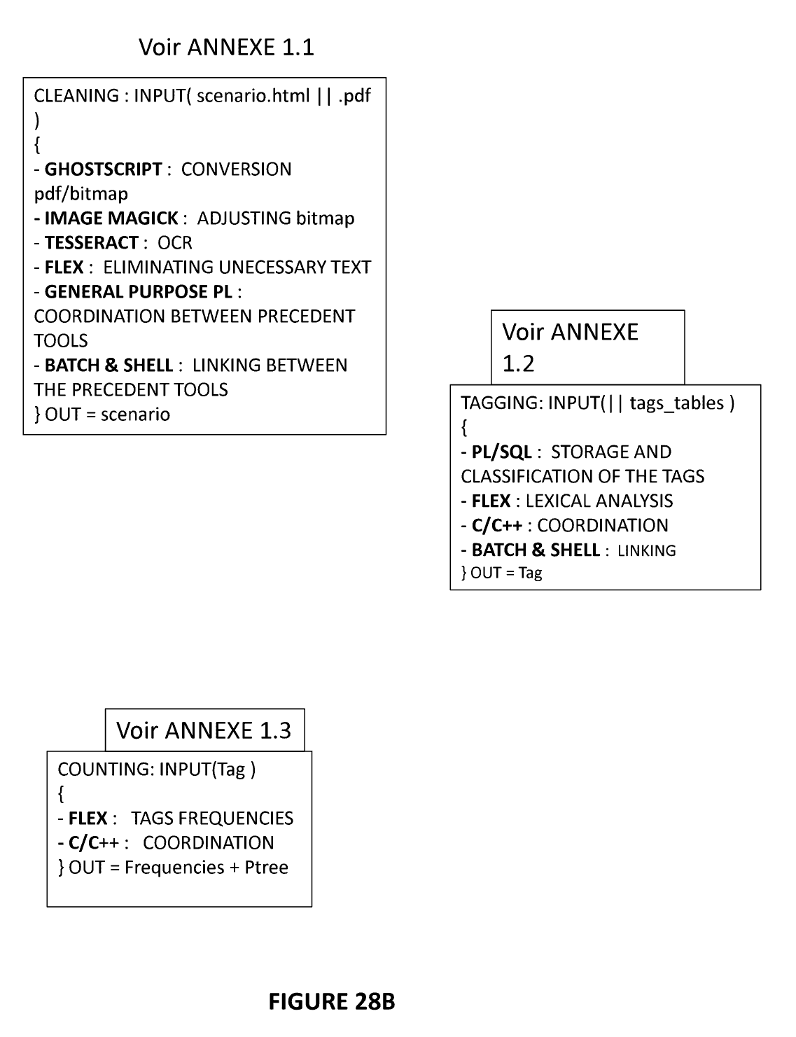

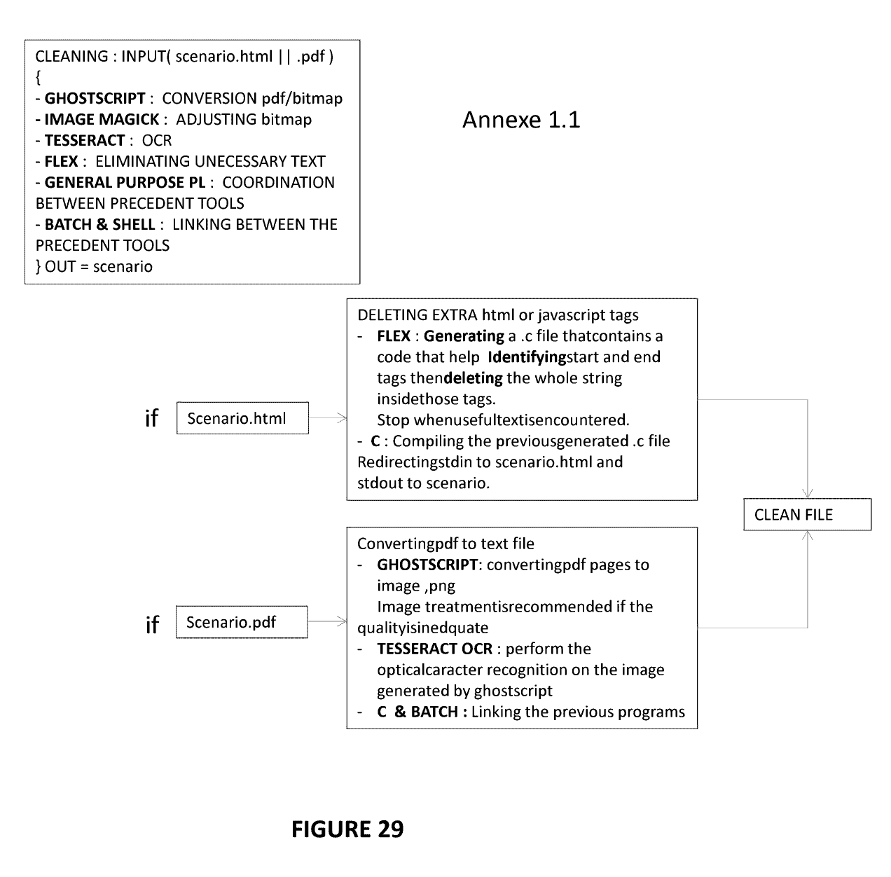

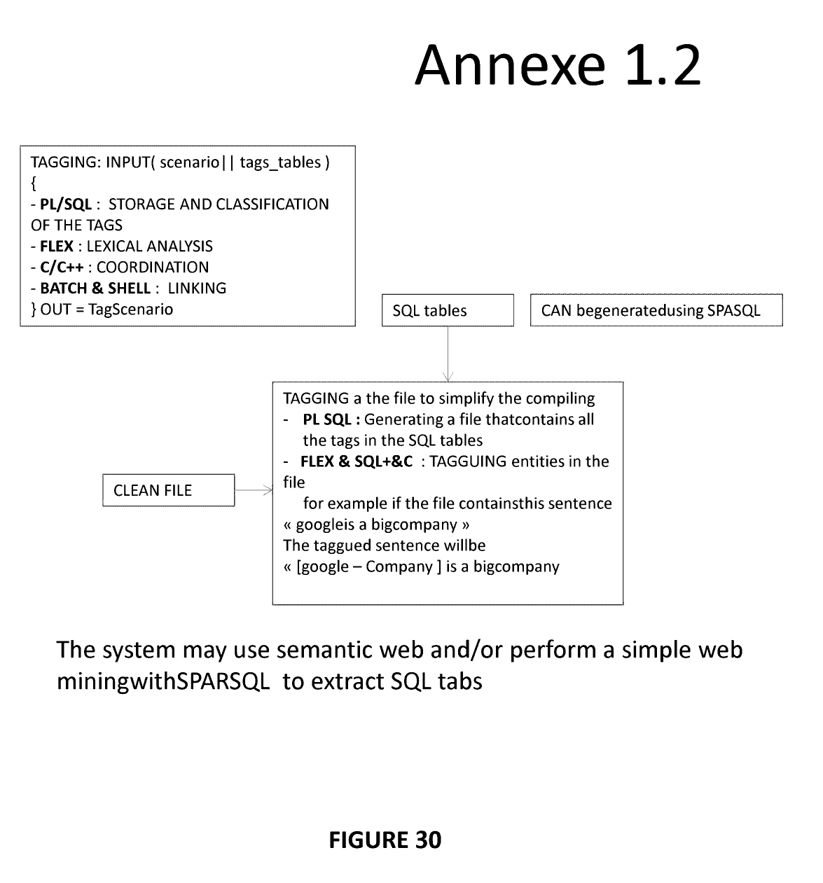

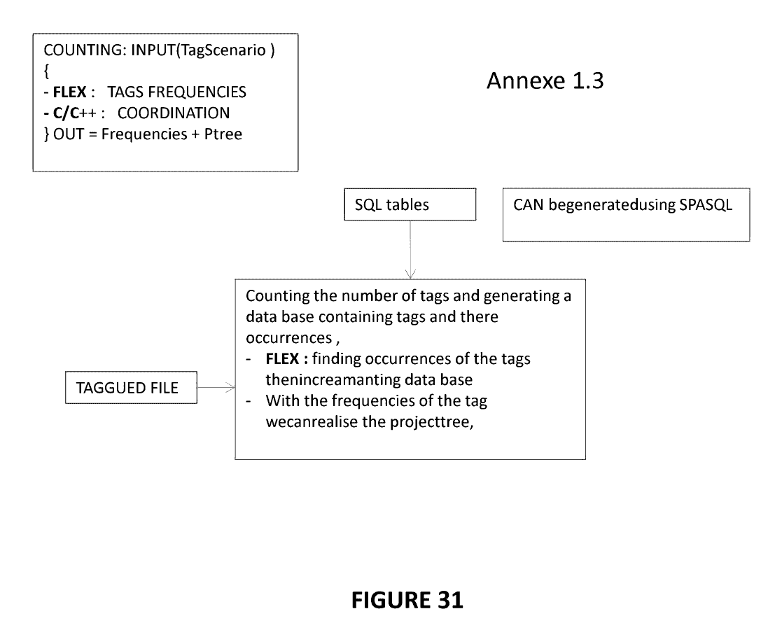

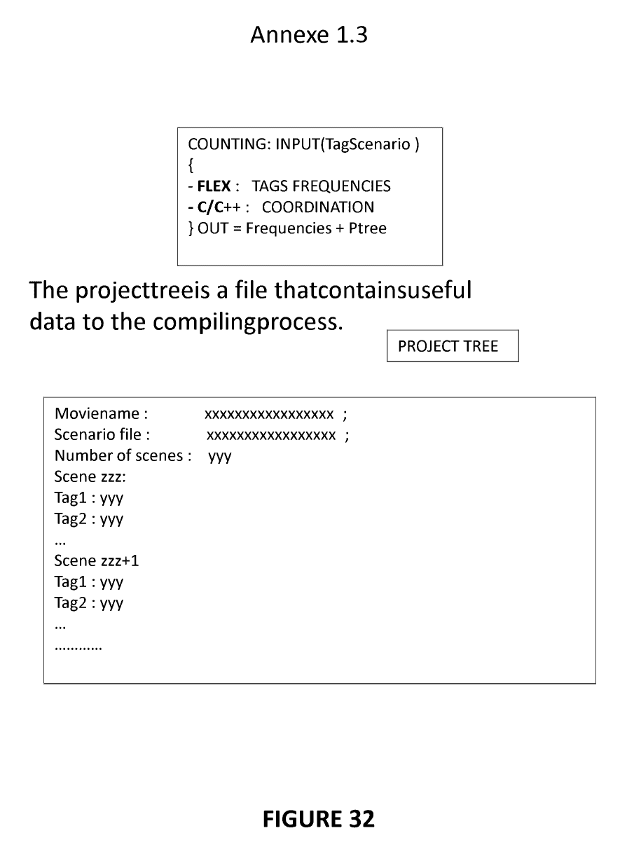

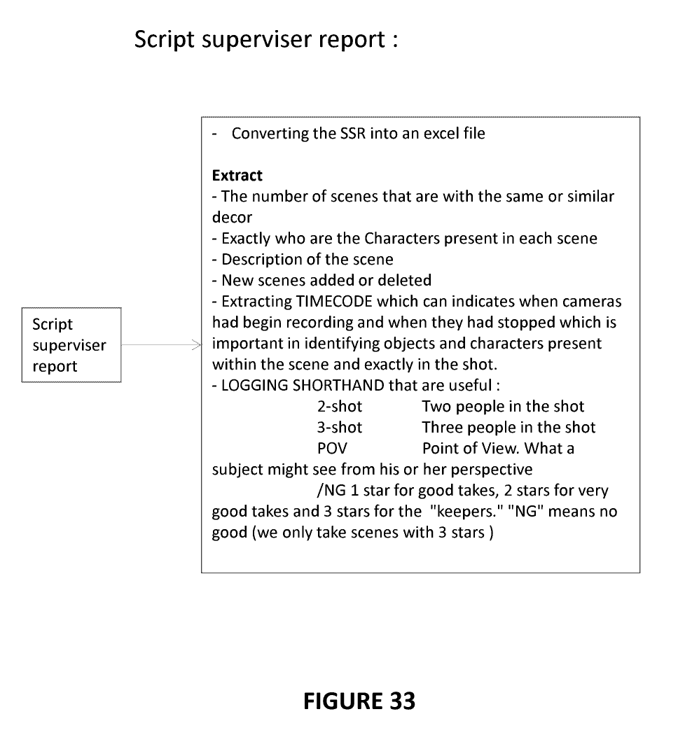

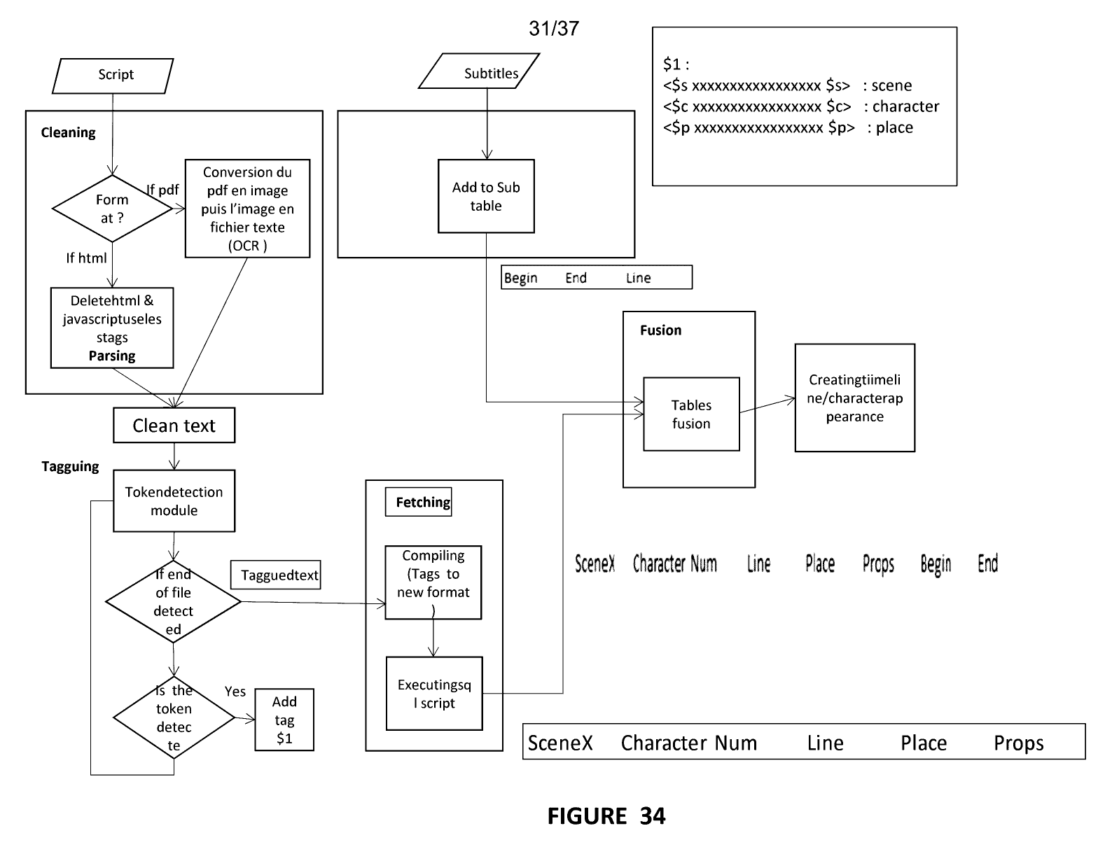

FIGS. 28A and 28B illustrate more details of the treatment process including a cleaning, tagging and counting process. FIG. 28B illustrates an example of the pseudocode for the cleaning process, the tagging process and the counting process shown in FIG. 28A. FIGS. 29-32 illustrate more details of the annexes of the treatment process and in particular the pseudocode for each annexe of the treatment process. FIG. 33 illustrates a script supervisor report of the system. FIG. 34 illustrates more details of the text treatment process of the system.

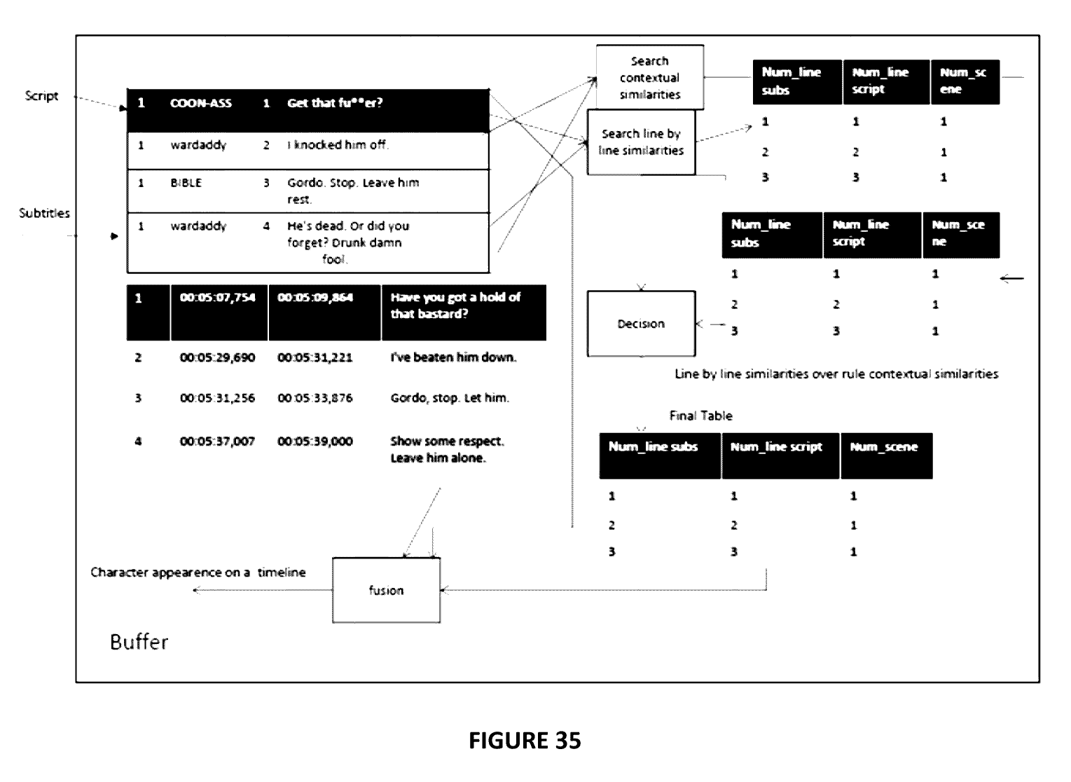

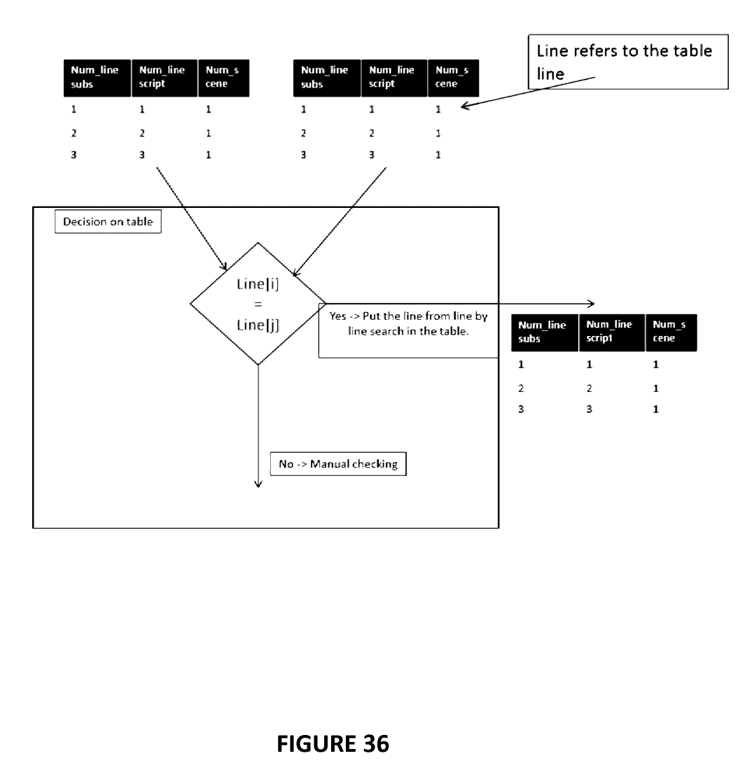

FIGS. 35 and 36 illustrate more details of a buffer of the system and how a script and subtitles for a piece of content are combined. The script has information that is obvious when it comes to dialog: Character name and the line of that character (what he says). On the other hand subtitles have character lines (final version) and time code, but do not have character name. The output needed from this operation is character name and time code and scene number mainly. Other information are added to the data base, like props, places (if detected in script and will be validated by the other input sources). This information allows to predict the appearance of celebrities/people and the products related to them and to the scene. For this fusion between script and subtitles, the system parses data and compares similarities between lines coming from script and lines coming from subtitles. Comparison is done word by word, line by line and dialog (group of lines) by dialog, since changes frequently occur between script and the final video content.

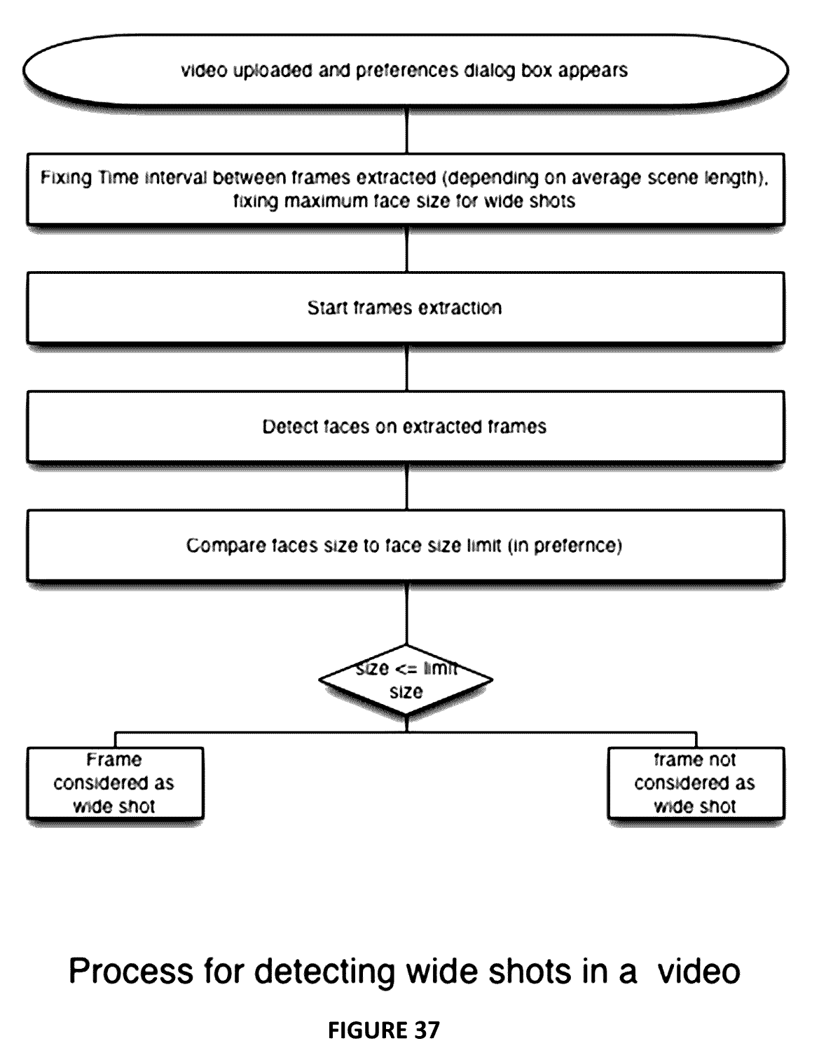

FIG. 37 illustrates an image recognition process and framing. In framing, the frames of the video are taken apart and compared for similarities (by color and/or shape recognition) and each images that is not similar to the previous images, according to the sensitivity factor, is saved. The amount and the interval of images depends on the sensitivity that is applied for the color and shape recognition) each saved image has a unique name. Other methods like Codebook can be used for framing: (consider first frame as background when a for-ground is detected the frame is selected, New background detected frame is selected etc. An alternative would be the automatic detection of wide shots (maximum zoom out) and the system presents the user with the image that has the maximum of an overview to tag as many products in a frame as possible.

PROCESS: A facial detection is launched for each frame to detect characters faces and then the faces size is calculated (pixels or other) and compared to the frames size (resolution or other). If the faces size is less or equal than a predefined limit (or compared with the other frames) we can deduct that the frame is considered as a wide shot, this method is used to compare between successive images that have humans in them.

The framing of the system may also add auto prediction to find products inside frames. The image recognition module consists of a set of tools methods and processes to automate (progressively the operation of tagging frames and celebrities (or more generally humans appearing in videos). The following methods and technologies may be used or their equivalent: People counting method that combines face and silhouette detection, (Viola & Johnes), LBP methods, Adaboost (or other machine learning methods), Other Color detection and Shape/edge detection, Tracking (LBP/BS or other), For-ground and back ground detection methods like codebook are other. These methods and techniques are combined with information inputs from Product and celebrities modules and semantic rules.

Product prediction system will try to find products inside frames automatically based on image processing techniques (Face detection, face recognition, human body pose detection, color based recognition and shape recognition) and artificial intelligence methods (Auto-learning, Neural networks, auto classifier . . . )

The framer may also use shape recognition. In a computer system, shape of an object can be interpreted as a region encircled by an outline of the object. The important job in shape recognition is to find and represent the exact shape information.

The framer may also use color recognition. It is well known that color and texture provides powerful information for object recognition, even in the total absence of shape information. A very common recognition scheme is to represent and match images on the basis of color (invariant) histograms. The color-based matching approach is used in various areas such as object recognition, content-based image retrieval and video analysis.

The framer may also use the combination of shape and color information for object recognition. Many approaches use appearance-based methods, which consider the appearance of objects using two-dimensional image representations. Although it is generally acknowledged that both color and geometric (shape) information are important for object recognition few systems employ both. This is because no single representation is suitable for both types of information. Traditionally, the solution proposed in literature consists of building up a new representation, containing both color and shape information. Systems using this kind of approach show very good performances. This strategy solves the problems related to the common representation.

The framer may also use face detection and human body pose detection (for clothing detection) or any other equivalent method. A popular choice when it comes to clothing recognition is to start from human pose estimation. Pose estimation is a popular and well-studied enterprise. Current approaches often model the body as a collection of small parts and model relationships among them, using conditional random fields or discriminative models.

The framer may also use artificial intelligence (AI). The AI techniques that may be used for object recognition may include, for example, Learning machine, Neural Network, Classifiers.

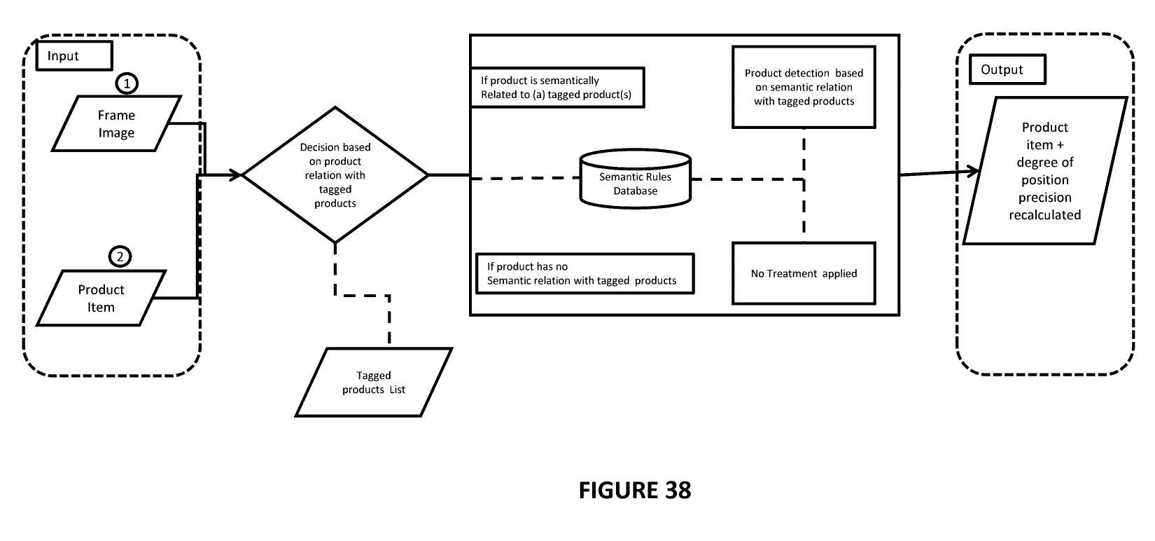

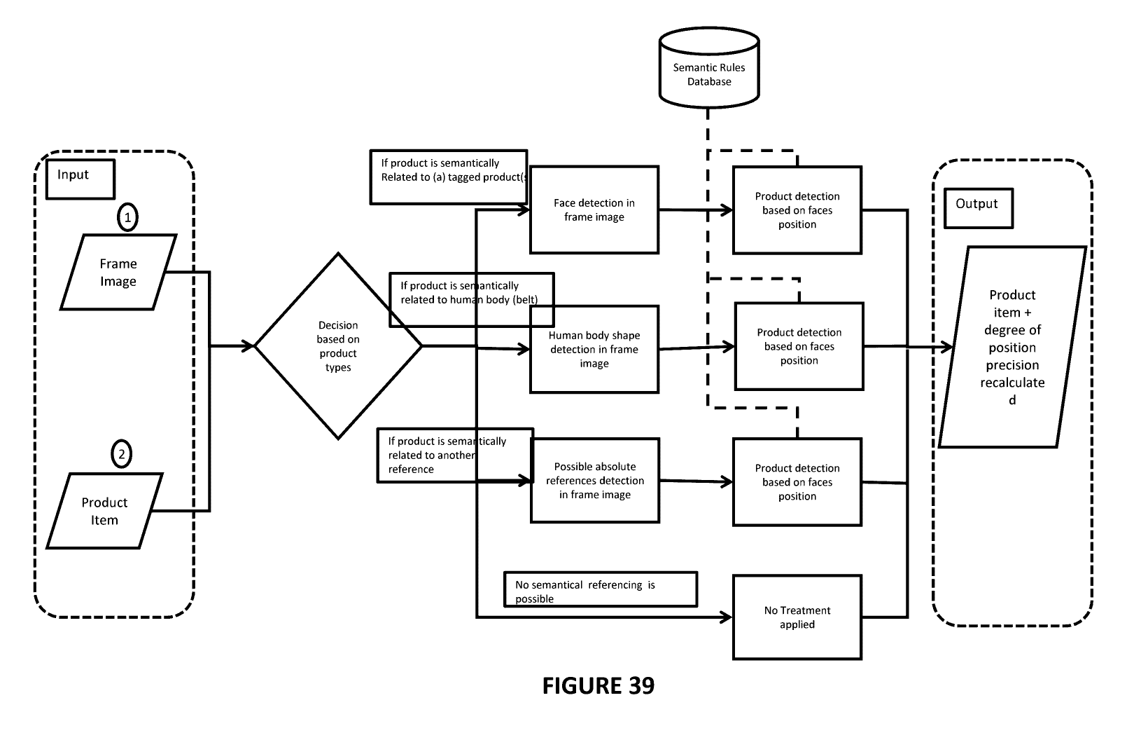

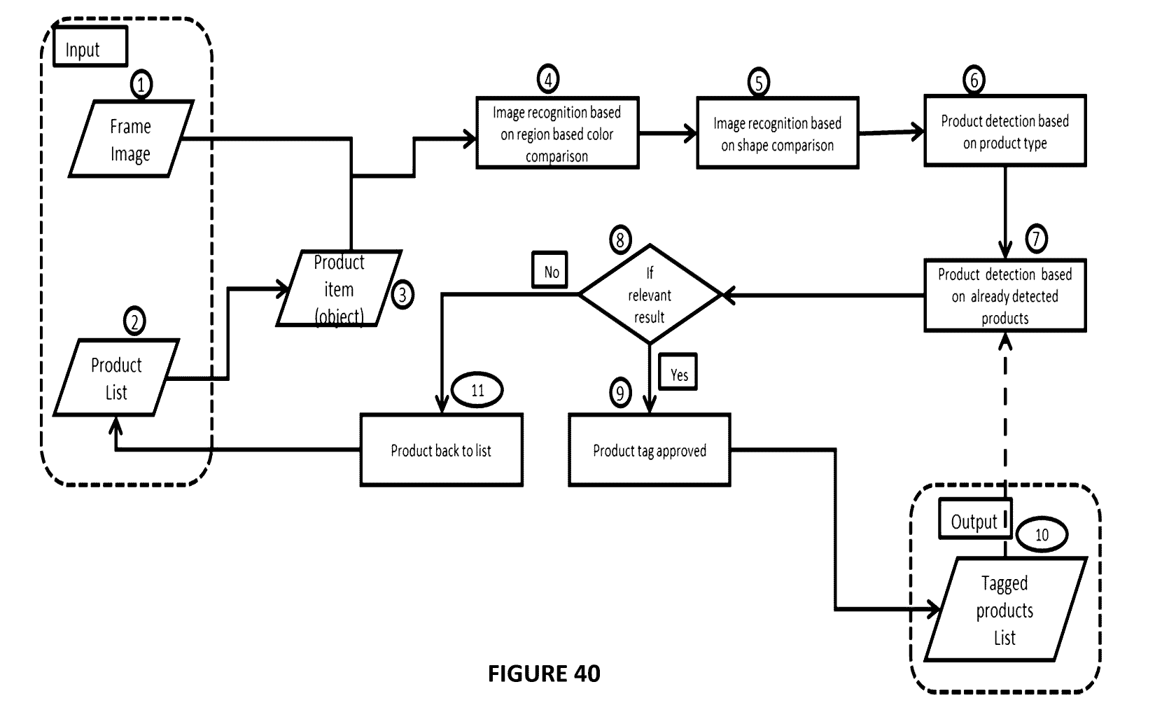

FIGS. 38 and 39 illustrate a product placement process of the system and the detail of that product placement that is also described below with reference to FIG. 40.

FIG. 40 illustrates a process for tagging products and in particular automatically Tagging a fixed set of products in a fixed set of images and the process of the image recognition procedure. The input may be: 1—image frame from media (1): image extracted from a video. 2—products set (2): a list of product items to be detected in the video, each product/item (3) must contain enough information about the product/item: name, image, color (optional), product type or class.

Products classes are predefined according to products nature and properties. A set of stored rules will define the possible relations between product classes. Reduced to the letter A further in this process. A set of stored rules will define the possible relations between product classes and fixed references (like faces, human body and other possible references in a video). Reduced to the letter B further in this process. The rules are deduced from manual tagging also as XY coordinates, product categories and groups of products are stored and analyzed.

Let's define “alpha” as a variable expressing the degree of tagging precision for a defined product. “alpha” increases when the certitude of the tag increases and decreases when the number of candidate regions increases.

Step 1: image recognition using region-based color comparison (4). This is simply processing one of the region-based color comparison methods to the product item and the image (frame). The color of the product can be read directly from the product properties (as a code) or detected from the product image. This step will eliminate not useful color regions from the scope of detection and will increase.

Step 2: image recognition based on shape comparison (5). This is simply processing one of the shape comparison methods to the product item and the image (frame). It is important to take in consideration the results of the Step 1. We consider only not eliminated regions to process in this step. The shape of the product can be detected from the product image or deducted from the product type or class or other. This step will eliminate some regions from the scope of detection and will increase “alpha”.

Step 1 and 2 (can be done in parallel).

Between STEP2 and STEP3: any other method for object detection in an image or a set of image can be processed also at this time of the process to increase certitude “alpha” and decrease false positives.

Step 3: product detection based on product type (5) (see FIG. 40). This part is a combination between image processing and artificial intelligence. This part takes in consideration the results of the previous steps. If the decision of tagging the product is still undecided, we use the set of rules B to try to increase precision and decrease false positives: based on the product class we can create another set of candidate regions in the image by referring to a fixed or easily detectable reference.

Example: a tee shirt (sunglass) is 99% of the cases very close to a face. This example is a way of representing one rule of the set B in easy human language. This will increase the precision index “alpha”.

Step 4: product detection based on already tagged products (6) (see FIG. 40). Already tagged products can be used as references to help the system decide for the tagging of the other products. This increase the will precision index “alpha”.

Example: a shoe can be detected with more certitude if we know where are the pants:

Time for decision (8): After the combination of these steps, we can see if the index “alpha” is enough to consider that the product is tagged with certitude. The product is than considered as tagged or sent to the list again to be processed again through the steps. A product state can change to tagged after the second process cycle as it can be tagged thanks to a relation with an already tagged product. Manual tagging and validation over rules automated system recommendations.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claim.

1. An apparatus, comprising:
a backend system that receives a piece of content having a plurality of frames and tags each frame of the piece of content with information about an item in the frame to generate a plurality of tagged frames;
a display device that receives the piece of content from the backend system; and
a computing device that receives the plurality of tagged frames from the backend system wherein the computing device displays one or more of the tagged frames synchronized to the display of the corresponding one or more frames of the piece of content on the display device.

2. The apparatus of claim 1, wherein the display device is part of the computing device so that the piece of content and the one or more synchronized tagged frames are displayed on the same display.

3. The apparatus of claim 1, wherein the display device and the computing device are separate.

4. The apparatus of claim 1 further comprising a wearable computing device on which a user indicates an interesting moment of the piece of content for later viewing.

5. The apparatus of claim 4, wherein the wearable computing device is one of a smart watch device and a pair of glasses containing a computer.

6. The apparatus of claim 1, wherein the computing device further comprises a sensor to detect a gesture of the user to identify a frame of the piece of content.

7. The apparatus of claim 6, wherein the sensor is an accelerometer.

8. The apparatus of claim 1, wherein the backend system further comprises a tagging component that tags each frame of the piece of content using one or more of a script and subtitles.

9. The apparatus of claim 1, wherein the backend system further comprises a product component that groups similar products together.

10. A method, comprising:
receiving, at a backend system, a piece of content having a plurality of frames;
tagging, by the backend system, each frame of the piece of content with information about an item in the frame to generate a plurality of tagged frames;
displaying, on a display device, the piece of content received from the backend system; and
displaying, on a computing device, one or more of the tagged frames synchronized to the display of the corresponding one or more frames of the piece of content on the display device.

11. The method of claim 10, wherein displaying the piece of content and displaying the tagged frames occur on the same display device.

12. The method of claim 10, wherein displaying the piece of content and displaying the tagged frames occur on different display devices.

13. The method of claim 10 further comprising indicating, on a wearable computing device, an interesting moment of the piece of content for later viewing.

14. The method of claim 13, wherein the wearable computing device is one of a smart watch device and a pair of glasses containing a computer.

15. The method of claim 10 further comprising detecting, using a sensor of the computing device, a gesture of the user to identify a frame of the piece of content.

16. The method of claim 15, wherein using the sensor further comprises using an accelerometer to detect the gesture.

17. The method of claim 10 further comprising tagging each frame of the piece of content using one or more of a script and subtitles.

18. The method of claim 10 further comprising grouping similar products together.
